(19) United States
(12) Patent Application Publication
(10) Pub. No.: US 2020/0160174 A1
(43) Pub. Date: May 21, 2020

(54) UNIVERSAL GEOMETRIC-MUSICAL LANGUAGE FOR BIG DATA PROCESSING IN AN ASSEMBLY OF CLOCKING RESONATORS

(71) Applicant: NATIONAL INSTITUTE FOR MATERIALS SCIENCE, Ibaraki (JP)

(72) Inventors: Anirban BANDYOPADHYAY, Ibaraki (JP); Subrata GHOSH, Ibaraki (JP); Daisuke FUJITA, Ibaraki (JP)

(21) Appl. No.: 16/635,900

(22) PCT Filed: Aug. 2, 2018
(86) PCT No.: PCT/JP2018/028962

§ 371 Date: Jan. 31, 2020

(30) Foreign Application Priority Data
Aug. 2, 2017 (JP) 2017-150171

(51) Int. Cl. G06N 3/08; G06N 10/00; G06N 3/04; G06N 99/00

(52) U.S. Cl. CPC G06N 3/08; G06N 99/007; G06N 3/0418; G06N 10/00

(57) ABSTRACT

Big data, which is too massive to analyze instantly, could cause various problems, including threats to the security by terrorism and intellectual crimes hiding behind its huge volume and complexity. Using topological information as key unit to encode information, every single piece of information is converted into a topology or geometric shape and encoded in a clock without requiring software programming by a human. Each of the converted piece of information itself indicates an event, a decision, etc. that has its own significance/meaning. Geometric shapes integrate within their single decision time and again to find the intricate pattern of any event, including the above-mentioned threats.

### TECHNICAL FIELD

Big data cannot be processed using linear tapes (Turing machine) that were used for the last hundred years. The present invention relates to the invention of a new language that solves the data overflow problem. The present invention introduces a new language where letters are geometric shapes. We introduce a new class of materials that use our universal language using its periodic oscillations. Therefore, the present invention covers chemical synthesis, computer science, mathematics and linguistics. The information is not “bit” it is a clock. The clock “ticks” at specific time intervals to hold a geometric shape. To mimic “tick” a material vibrates resonantly at a particular frequency. Clocks self-assemble to memorize complex geometric shapes. The organic material self-assembles to mimic the self-assembly of clocks. Self-assembly of rhythm=self-assembly of time cycles=self-assembly clocks=time crystal or time jelly. In a clock, multiple frequency peaks arrange as geometric shapes. So, we call it a geometric-musical language. Clocks could be organic, inorganic, non-chemical, but its clocks should be able to change structure and assembly. It is possible to write, read and erase nested cycles in the jelly of clocks or jelly of time crystals. As the structure memorizes, using noise, we do not need continuous power supply for memory. We name the organic jelly as “brain jelly”. Geometric Musical Language (GML) needs fractal hardware to implement. The hardware is always a jelly of time crystals or assembly of clocks.

### BACKGROUND ART

To process information, the existing computers flow a current through its circuit. When unit of information is clock, a static circuit does not work. Inspired by clocking of virus and other biological materials, time crystal concept was proposed in 1977 by A. Winfree [non-patent document 6]. Time crystals are made of clocks, like spatial crystals that we see around. Similar to spatial crystal where at different directions we find different arrangement of atoms, if a system point moves a complete circle in a clock, it finds different times at different intervals. It was argued that time crystals self-assemble to build the biological life form. The actual structure of information and integrating the information to make decisions were not constructed. Currently, time crystal is revived by Frank Wilczek in 2012 [non-patent document 7]. Time crystal can have a classical and a quantum version. Nature produces time crystal. However, it was never conceived that time crystal is the language how nature speaks. In the present invention, we consider that time crystal synthesis is how nature processes information. We design bio-inspired time crystals. Cavity resonators have a resonance frequency but to be an effective clock, the frequencies should be played in a sequence. Creating a fractal like architecture using the principles of self-assembly has an advantage; one can use wide ranges of times at various spatial scales, as all scales holds particular size of cavity resonators. The commercial advantage of fractal assembly of clocks was never explored. The similarity triggers coupling of clocks and that coupling changes the conformation in the system, which again triggers conformational changes in the system. It may spread like tree branches. Therefore, once the writing reading erasing and reading process starts in the system, the supramolecule grows and decays continuously and in course of that development an astronomically large number of clocks are born.

Programmed self-assembly has always been a subject of study. Automation industry desires growing complex architectures spontaneously. However, self-assembly of clocking materials that vibrates as if holding the geometric shapes may be used to do computing. During self-assembly of such clocking materials one geometric shape may change to another. This means simply executing a computer program by growing or destroying molecular structures. Not a significant amount of research has been done in the field of clocking or rhythmic oscillations triggering conformational changes in a material. The reasons are several. The first reason concerns many-body interaction. When phase space plays a role in structuring information, the path is infinite. Thus far, phase space was exclusive to quantum. It was believed to be a domain that cannot be seen, measured or manipulated. It used to be infinite in size and named as Hilbert space. Here, in the present invention we get into the engineering of phase space. It is not about the resonance peaks of an oscillator or a material. But, we are concerned about the phase associated with the resonance frequency. In the history of designing oscillators, multiple resonance peaks were observed in some materials. However, writing resonance states and erasing them was never studied. It was never essential to create such materials. In the present invention, this particular kind of feature is addressed, where the unit of memory or information is a resonance peak frequency and intensity, not conducting state which are often used in the computer chips.

“Brain jelly” invention under consideration is primarily inspired by human brain's neural network. It covers a large aspect of linguistics. Linguistic research shows that common geometric shapes are fundamental to every language of humans. The historical perspectives were consolidated by Noam Chomsky's argument that all human languages are the same. Moreover, human brain operates via power scaling law, in the present invention the similar technology has been attempted to replicate, this can reduce the power consumption largely. Therefore, entire brain must have a unified language and that is not what we speak. It is the fundamental language of the hardware. The discovery of a true language could be industrially very useful. One could in principle talk to a protein using suitable set of frequencies. All the signals would have a proper phase relation. If chosen rightly, it would change the medical science. Most diseases affect proteins, folds them so badly that they do not recover. We can wirelessly correct errors without drug. The robots can use this language, as it would drastically reduce the programming complexity. A language that the hardware uses and eliminates the necessity of programming like a human brain has been a key target of the present invention. We discuss this below.

Programmable matter was proposed in 1991 by Toffoli in MIT [non-patent document 8]. However, its organic version does not exist. Human brain is a programmable matter, a jelly made of neuroglia and neurons. The architecture changes continuously, as it learns, the wiring is not a stable structure and no eventual equilibrium is reached ever. Neuron and glial jelly is the inspiration for the present invention “brain jelly”. The “brain jelly” is a multiband frequency sensor and adapts with the system to absorb and produce more complex frequency patterns. Its ability to restructure to generate new kinds of resonance frequency patterns is unique. Any sensory data is stored as periodic resonant oscillations of frequencies in a sequence, so it makes a clock. There are plenty of reports on the shape change materials as a particular energy signal is pumped, or provided. However, no report exists on the shape change occurs to emulate a biological rhythm. Thus, the present invention is an attempt to construct flexible plastic hardware to eliminate the necessity of writing the software codes forever. Brain does not require software engineer to operate. The wiring of neurons grows and regrows, here the cavity geometry changes and the organic molecules regrow forming new wiring.

Developing a material where a large number of clocks residing side by side and one inside another is a key to build a fractal structure. If a fractal assembly is used to build a language processor, the hardware can shrink data by replacing complex geometric shapes with simple and fewer ones. Humans do this often. It is the key factor to the present invention. The fusion of geometric language and musical instrument-like material that plays the sound has not been done. One attempt made few years back, where a geometric space filled with many frequencies was created. However, the frequencies never stored the peculiarities of a geometric shape, like, angles, curvatures number of arms and there was never any grammar constructed to convert any geometric shape into a clocking vibrations for storing it as is in a material. The word “music” is used to signify compositional features of a time crystal. To store particular information of geometric structure, at certain intervals a burst of signal of particular frequencies emit. The time gap between two neighboring bursts hold the information of geometric shape. Thus, the phase space holds information not the intensity of signal or frequency. The present invention resolves several issues related to nature of information and proposes a language that is generic and akin to a material.

### CITATION LIST

### Patent Literature

PTL 1: U.S. Pat. No. 7,635,094 B2
PTL 2: U.S. Pat. No. 6,430,511 B1
PTL 3: EP 1358667 A1

### Non Patent Literature

NPL 1: A successive layer-by-layer assembly of supramolecular frameworks driven by a novel type of face-to-face π+-π+ interactions. CrystEngComm, 2013, Advance Article, DOI: 10.1039/C3CE41230J, Received 25 Jun. 2013, Accepted 1 Aug. 2013, First published online 2 Aug. 2013.
NPL 2: Frequency stabilization in nonlinear micromechanical oscillators, Dario Antonio, Damian H. Zanette & Daniel Lopez, AffiliationsContributionsCorresponding author, Nature Communications 3, Article number: 806 doi:10.1038/ncomms1813, Received 27 Jul. 2011 Accepted 30 Mar. 2012 Published 1 May 2012.
NPL 3: Supramolecular organisation of tri-n-butyl phosphate in organic diluent on approaching third phase transition, S. Nave, C. Mandin, L. Martinet, L. Berthon, F. Testard, C. Madic and Th. Zemb, Phys. Chem. Chem. Phys., 2004, 6, 799-808, DOI: 10.1039/B311702B Received 22 Sep. 2003, Accepted 12 Dec. 2003 First published online 20 Jan. 2004.
NPL 4: Supramolecular Structures of Enzyme Clusters, Javid N, Vogtt K, Roy S, Hirst A R, Hoell A, Hamley I W, Ulijn R V, Sefcik J., J Phys Chem Lett. 2011 Jun. 16; 2(12):1395-1399. Epub 2011 May 18.
NPL 5: Modulation of contact resonance frequency accompanying atomic-scale stick-slip in friction force microscopy, Pascal Steiner, Raphael Roth, Enrico Gnecco, Thilo Glatzel, Alexis Baratoff and Ernst Meyer, Nanotechnology Volume 20 Number 49, 495701, doi:10.1088/0957-4484/20/49/495701, Published 6 Nov. 2009.
NPL 6: Biological Rhythm Research 8, 1; The Geometry of Biological Time (Springer, New York, 2001), 2nd ed).
NPL 7: Quantum Time Crystals, Frank Wilczek, arXiv:1202.2539v2 (2012).
NPL 8: Tommaso Toffoli. Norman Margolus, Programmable matter: Concepts and realization, Physica D: Nonlinear Phenomena, Volume 47, Issues 1-2, 1 Jan. 1991, Pages 263-272.
NPL 9: Generalized theory of interference and its applications, S. Pancharatnam, Proc. Indian. Acad. Sci. A 44, 247-262(1956).
NPL 10: Hazewinkel, Michiel, ed. (2001), “Lie algebra”, Encyclopedia of Mathematics, Springer, ISBN 978-1-55608-010-4.

### SUMMARY OF INVENTION

### Purpose of Invention

The purpose of the present invention is to build a self-reconfigurable hardware that processes a geometric language due to its natural vibrations. We design and realize a supramolecular structure namely “brain jelly” that can learn to morph the operation of biological machines as time crystal. In the material, several time crystals are wired together. They change time crystal symmetry and wiring with learning. The jelly of time crystals absorbs information as clocks arranged in a geometric shape. Then the jelly changes its hardware so that next time if the same information arrives, the jelly resonates strongly. There is a grammar of geometric shapes. The basic time crystals of the jelly are designed to naturally vibrate those geometric shapes and edit if required. The jelly naturally simplifies the geometric shapes by identifying self-similarity. This process helps in drastically reducing the amount of information. One or more geometric shapes are to be stored along with its repetition rules. Later these seed like geometric shapes are repeated to regenerate the full pattern.

The inventors of this invention conceived a self-evolving architecture based on clocks that senses any form of input signals and converts into a clock that holds geometric shapes. The clock is special as it holds geometric shapes using the phase of resonant signals. Change in phase can morph a geometric shape. The path adopted by phase is the dynamics of a system and used similarly as a letter is used in the language in this invention, named as Geometric Musical Language (GML). The invention of this new language relates to the building of time crystal structure by materials synthesis or pure device fabrication technologies. A new material is essential to implement the language because of its dynamics. Time crystal theoretically proposed to exist in biology, in 1977, is experimentally realized here to build structurally evolving material to process this language.

This invention provides an evolving structure made of time crystals that changes itself with learning. The device is a sensor that senses the environment spontaneously and converts any stream of signals into a composition of clocks. These clocks are special. They “tick” at certain time intervals to hold a geometric shape. Thus, when all the clocks run, the pattern of frequencies and phase make a 3D shape. This is the language invented herein.

In this specification, the inventors define this electronic, photonic, magnetic, mechanically operating organic or inorganic jelly or even composition of electronic devices to act as “a perpetual clocking self-assembly device” or simply “brain-jelly”, as cyclic arguments grow perpetually without any external instruction. Thus, the inventors conceive a hardware that can generate an enormous amount of higher level arguments as nested clocks or rhythms generating a jelly of time crystals. This language operates without writing a single line of software code in the hardware system. The language uses geometric network alone to represent every single form of information in the universe.

### Effects of Invention

All these advantageous changes are summarized below.

1. Geometric-musical language replaces the software programming: A program instructs tasks, when a computer is designed to emulate events as is, then, instructions are meaningless. Seed of an event is a geometric shape evolving as a function of time. Temporal relationships between elementary events incorporate decisions. The distinct identity of questions and answers, situation and decision does not exist. An indefinite fractal network of statement makes sure, there is no logically defined statement, thus, faintly related events even are extracted. We get a science of emotions and psychological behaviors. Any form of sensory information is converted into clocking time crystal, where each clock holds a geometric shape. There is no static information, all are dynamic events, and no events are kept isolated, all are associated by some geometric links. These geometric links are equivalent of programming.

2. The present invention reports a new class of fractal cavity resonators. Such a device was never proposed earlier. In conventional cavity resonators, only the waveform meeting exact boundaries resonates, but in the fractal cavity resonators, wavelengths that are much shorter and much longer could resonate by nesting. Its rapidly oscillating boundaries enable quantum effects to play a role. Leaking membranes or boundaries enable carriers to communicate globally and create non-local standing waves or resonance. Thus, a language demands a very new class of device.

3. The present invention fuses information with the structure in a dynamic way, the structure follows as the information changes. It is like a material changes its shape depending on the light color falls on it, or sound structure, or even different kind of touch. Apart from working as a shape change materials at wide frequency ranges, the material can come up with unique shapes. Geometric musical language processing matrix is a fusion product of shape change memory switching devices. The most important part of information is the relative initial phase, a little error in it, can change the entire output. The origin of uncertainty in nature is underpinned by this language. Matching with nature means correcting the phase mismatch.

4. Conversing with Geometric Musical Language means rewiring clocks holding geometric shapes, creating and terminating various such clocks. Language processing material implements several new technologies (i) unique energy “window effect” by resonance chain. The cavity resonators grow covering the constituents to a much larger size, while growing the frequencies of time crystals are naturally chosen discretely such that innermost layer's energy is not absorbed above. (ii) time crystal introduced by A. Winfree in 1977 is realized experimentally. (iii) Geometric musical language leads to Toffoli's “programmable matter”. Until now, programmable matter did not have a proper organized generic product. The present invention is a complete product where organic synthesis and geometric musical language is connected.

5. The number of topological maps or phase maps that could run in a time crystal could be much larger than the number of clocks by which the crystal is made. Ordered factor of a number actually tells us how many cycles come together. Use of phase as a fundamental to build a language enables us with a technology to keep number of “bits” constant, yet change the coded information fundamentally by editing phase. This is similar to the human voice technology where a particular word pronounced in various different ways gives significantly different meanings.

6. The language does not use any static geometric shape as its letter. This is the fundamental difference with the human languages. Manmade languages require to explain static objects. The motion of objects is explained with separate words called “verb”, properties need “adjective” to add a quality. Here in the geometric musical language, the relative temporal evolution of geometric shapes alone includes all features. Even in the linguistic terms, this language is a novel exhibition of grammar, where, a system processing this language could sync with any unknown language and adopt its grammar. The ability to manipulate the rule of morphing 1D, 2D, and 3D geometric shapes enables the language processing hardware to build language for any unknown dynamic system, learn new languages.

7. Continued fraction Geometric Algebra (CFGA): Not just dynamics, the system allows mathematical processing using geometric drawing. Geometric constants e, π, φ and imaginary index i, build unique relationships to map a specific infinite series that represents a local nested rhythm network. The relation also provides a geometric constant that is essential to build any linear relation or variation in the network. We can do entire complex mathematics of infinite series, simply by drawing the nested cycles; this is called continued fraction geometric algebra (CFGA).

8. A new information theory is invented as a byproduct of geometric musical language. Binary bits are considered as information, now, a cycle made of frequencies or clock depicting a geometric shape is the information. The information expands, the equivalent Bloch sphere assembly or time crystal expands with the addition of a new geometric shape, side by side. Big Bang like expansion provides insight into the integrated information architecture in nature and biological systems.

9. Use of clock that uses frequencies is superior to logic gates that use bits, because (1) a system point running along the perimeter of a circle is itself a memory that needs not to be refreshed ever. At the same time, it makes a decision. (2) System point is never lost at a far distant place in the self-assembled time crystal architecture acting similar to an operational circuit of conventional electronics. In the present invention, there are multiple system points, so it is distributive, no central control system is required to manage system points, no external user is thus required. (3) a clock is a rhythm hence automated clocks maintains time, over entire information architecture spontaneously, (4) a clock is a fractal harmonic oscillator hence can spontaneously self-assemble, an harmonic oscillations are included in the clock, (5) a clock can spontaneously reply by synchrony and de-synchrony so we do not need circuit connection to address, require minimum resources. (6) We do not need logic gate for rejection hence enormous power saving. (7) A clock made of frequencies in a rhythm is a natural sensor, we do not need to design any, (8) it is a natural filter as unmatched signals are rejected, noise is eliminated naturally. Some incredible feature of clock assembly is that (9) a clock can activate or cross check infinite loops at once via escape time (ET, one inside another) and IFS (Iterative function system, side by side) routes simultaneously. (10) The clock assembly memorizes any geometric shape or symmetry in 1D, 2D and 3D, using only diameter and ratio of arc gaps. Hence the clocking matrix could emulate any “form of argument” as “geometric shape”. Simply by self-assembling the evolving fractal clock network can sense, decide, respond and transform by itself.

10. Fractal cavity resonator generates sensors that have enormous resolution because a shape made of clocks could have infinite journey in its clocking matrix. Fractal resolution of an image is ultimate, one could zoom perpetually and yet get information inside. When metric of prime is used as a journey of clocks inside a pixel, there is no change of repeating a pattern. By continuous zoom, one would get new patterns.

### BRIEF DESCRIPTION OF DRAWINGS

FIG. 1A The left panel shows plot of function Cos x+Cos y+Cos z and the right panel shows the plot of A(Cos x+Cos y+Cos z)+B(Cos x Cos y Cos z) when A=3, B=4. 12 singularities arrange in 8 ways, so we get lie alzebra to govern the device.

FIG. 1B There are shown schematic presentation of bit, Qubit, (101) and, Qudit with three points holding a geometric shape (102), and clock representation of a Qudit (103). Phase part and “tick” of a clock (time cycle) is shown. A system point rotates along the perimeter to construct the clock. Clocking Bloch sphere holding a triangular geometric shape (104) is also shown.

FIG. 2 There are shown clocking Bloch sphere of FIG. 1B holding a triangle (basic time crystal, three time symmetries) in which three points of a triangle is sliced off, three new geometric shapes are written in three points (201), clocking Bloch sphere of FIG. 1B holding a square (basic time crystal, four time symmetries) in which three points of a triangle is sliced off, and four new geometric shapes are written in three points (202), and Integrated Information Architecture (IIA, 203).

FIG. 3 There is shown schematic presentation of processing of Geometric musical language in a hardware. The top row shows the real geometric shape and its equivalent time crystal is shown in the bottom row. A single geometric shape is decomposed or a complex disintegrated image is gradually integrated into one.

FIG. 4 There is shown schematic presentation of the concentric sphere that represents the successive growth of supramolecular architecture from the seed structure and the associated resonance energy bands.

FIG. 5 There is shown schematic presentation describing how cavity resonator makes a clock. Small cavities inside a large cavity occupies the minimum energy path to integrate two types of clocks. Branching creates new clock.

FIG. 6 There are shown harmonics of all fundamental frequencies in a clock. Basic time crystal concept and its 3D spherical presentation is shown.

FIG. 7 There is shown the manner in which “If” set of events transform into “Then” set of events.

FIG. 8 There is shown relative rotation of clocks in a self-assembling time crystal.

FIG. 9 There is shown schematic presentation in which symmetry breaking in the arrangement of the cavity resonators changes the resonance band of the system, hence the clocking network.

FIG. 10 There are shown the outputs of a classical time crystal and a quantum time crystal.

FIG. 11 There are shown the input and output of a multilayered clocking cavity resonator architecture. It processes the geometric musical language.

FIG. 12 There is shown self-assembly of a leaking, rapidly vibrating cavity resonator, where the time crystal is growing similarly.

FIG. 13 There are shown twelve layers, wherein each layer contains nine clocks, totaling 108 clocks. Clocks nest with each other to create binary pulse streams, or even crystals of various symmetries.

FIG. 14 There is shown self-assembly of clocks. Guests always make an inner contact with host.

FIG. 15 There is shown self-assembly of clocks. Guests always make an outer contact with host. It is called in-nest.

FIG. 16 There is shown self-assembly of clocks. Guests always make a cross contact with host. It is called out-nest.

FIG. 17 There is shown self-assembly of clocks. Guests are making all, inner, outer and cross contact with the host. It is called On-nest.

FIG. 18 There is shown binary stream output of a pair of clocks nesting with each other.

FIG. 19 There is shown schematic presentation in which morphing of geometric shapes is the grammar of Geometric Musical Language.

FIG. 20 There is shown transformation of fractal seeds. Seeds are a set of geometric shapes that repeat. But these seeds can also self-assemble at the seed level.

FIG. 21 There is shown schematic presentation in which self-assembled fractal seeds can undergo phase transition.

FIG. 22 There is shown an example of image processing describing step by step how an image is converted into a time crystal. Time crystal is always a fractal seed.

FIG. 23 There is shown an example of image processing in which seven different protocols are used to find different distinct time crystals for a single image.

FIG. 24 There is shown an example of converting the image transformation described in FIG. 23 into a time crystal.

FIG. 25 There is shown schematic presentation explaining creation of a new clock is fundamental or universal drive.

FIG. 26 There is shown a sound processing protocol describing a step by step process to determine the clocks in a sound signal.

FIG. 27 There is shown group formation of clocks in a sound signal.

FIG. 28 There is shown formation of a time crystal from a sound signal.

FIG. 29 There is shown an example describing how a time crystal generates linear curves.

FIG. 30 There is shown self-assembly of clocks linear curves.

FIG. 31 There is shown schematic presentation describing how time crystals detect a particular letter or sentence of a Geometric Musical Language even under extreme noise.

FIG. 32 There is shown self-assembly of clocks to represent a 3D structure.

FIG. 33 There is shown an experimental data of brain extracted microtubule for detecting a time crystal. The detection of a time crystal in microtubule is used in the present invention.

### DETAILED DESCRIPTION OF INVENTION

The present invention will now be explained in detail in correspondence to the claims.

<Description of the Features According to Claim 1>

The invention relates to a language based on geometric shape written in a clock, and then realizing experimental device that implements this language. The silent time gap between ticks holds the phase or arms of a geometric shape while the clock ticks at corner points of the geometric shape.

The language explores phase far beyond quantum mechanics. In quantum mechanics, there is a concept called geometric phase introduced by S. Pancharatnam in 1955 [non-patent document 9]. A classical clock when rotates full, to make a new beginning, no sign is left in the clock. No one could detect that it rotated a full swing. In quantum mechanics, one can detect, because the geometric phase counts, that traverses on a Bloch sphere. Now, when on an imaginary sphere of quantum with two classical poles incorporates a loop, it may construct a clock. And the inventors also consider that multiple singularity points exist on that topological path. Connecting the singularity points creates a geometric shape. This advancement from quantum mechanics is the foundation of the present invention. Nested Bloch spheres make an architecture of Bloch sphere that enables one to make a journey through various rates of time flow.

In the 1920s when Feynman and others introduced renormalization in quantum mechanics, they solved the problem of singularity by normalizing the two ends of an undefined domain. This invention uses the concept of A Winfree's time crystal introduced in the 1977 [non-patent document 6] to explore the singularity domain. Filling the undefined gap created by singularity with a Bloch sphere of a time crystal is the original concept introduced in the present invention. This technology not only brings a new class of materials, called time crystal, but also a new technology that enables using fractal clocks to encode the dynamics in a material that modulates the topological features.

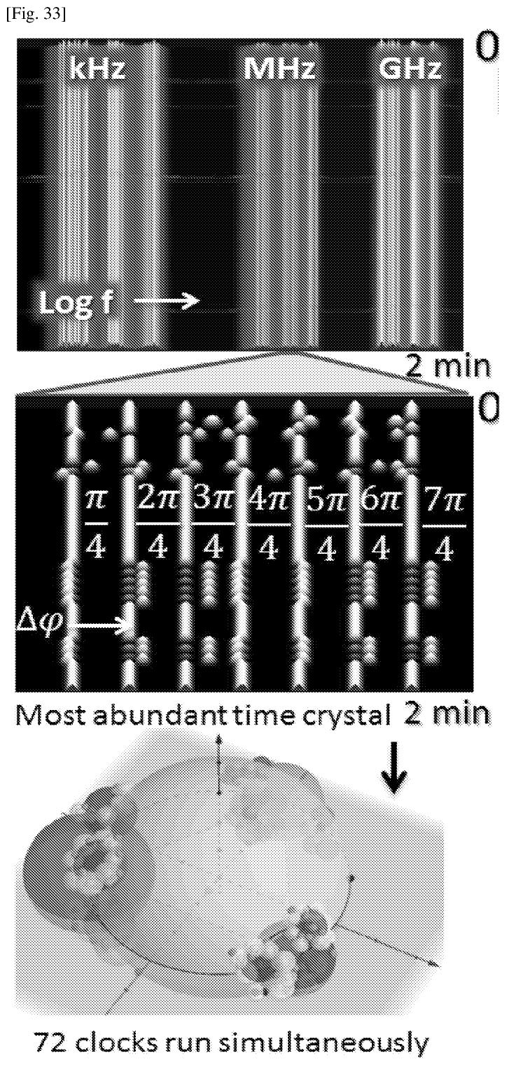

The invention according to claim 1 introduces the invention of topological feature modulating a material which is a jelly made of a new class of time crystals. The invention is inspired by time crystals observed in the brain extracted microtubule (see FIG. 33 and the time crystals were built using organic supramolecular architectures.

One important feature of the invention according to claim 1 is deviation from the basic concept of linguistics, where a static image or sound is used as letters to construct a sentence. Here in this language, transformation between geometries is a letter. Conversion of a triangle to straight line is an event in itself. Phase change between three points of a triangle could generate astronomically large number of events.

<Description of the Features According to Claim 2>

In the jelly of time crystals architecture of the invention according to claim 1, in each clock, a change in 360° phase is regulated by system point. A system point is created, sustained and deleted by the system spontaneously as required. The invention according to claim 2 details particulars of creating system points in a network of clocks or jelly of time crystals. One important aspect of a clock is often ignored. A clock cannot run, if there is no sub-clock defining its time. A minute clock does not run without seconds clock that perfectly matches its 60 steps. This simple fact is naturally implemented in the jelly of a time crystal. If a set of faster clocks integrate forming a perfect loop, a system point is born, which means creation of a clock, too.

Self-assembly of clocks is part of learning an event. Clocks hold a not more than two basic properties that enable them bonding with each other. Every clock hosts a not more than two guest clocks with particular diameter of its representative circles. If two neighboring clocks have similar sets of neighbors, each set having a sequence of clocks with similar diameters, then, they self-assemble. The self-assembly of clocks have several significances. Clocks self-assemble means materials using which the clocks are made, self-assemble. It means, a set of geometries lose their distinct identity at the higher level. A new geometric shape is born. The self-assembly of clocks could be such that two circles representing the clocks make inner contact, make a cross contact and make an outer contact.

When clocks self-assemble, two things can happen. First, self-assembling circles or clocks have only one system point, irrespective of the number of participating clocks. The output signal is binary pulse stream. Second, all the participating clocks have one system point each. The output is epicycloids. More is the number of clocks, more is the generation of intricate pattern in the epicycloids. Thus, Geometrical musical language has two classes of clock assembly governed by the system points. They are binary stream of pulses & fractal of epicycloids.

<Description of the Features According to Claim 3>

The clocking jelly architecture of the invention according to claims 1-2 transforms reversibly and irreversibly continuously with a definite architecture of Bloch sphere. The invention according to claim 2 details the Bloch sphere representation of the information structure. In a classical system, finite fixed states define a system logically. In the integrated information architecture of geometric musical language, classically defined states do not exist. Even in a Bloch sphere of quantum information theory, there are two classical states at the poles. In the present invention, as clocking is a primary entity in a Bloch sphere, the poles disappear. Instead of classical points, the clocking Bloch spheres have singularity points. The system point passing through the singularity points and completing the loop constitute a clock. The present invention uses a very different kind of Bloch sphere, even the name “Bloch sphere” may not suit it. The infinite homogeneous Hilbert space of Bloch sphere known in quantum system is not applicable here.

The present invention fills the singularity domain using an additional Bloch sphere. Thus inside the Hilbert space, we get a subset of new Hilbert space. In the quantum mechanics, always there is only one kind of Hilbert space. It is infinite and it collapses to either of the two classical points. Here the material exhibiting the clocking Bloch sphere holding the geometric shape do not have any classical solution. The material is always a fractal structure. The fractal grows side by side or one inside another. Similarly, Hilbert spaces grow side by side and one inside another. All Hilbert spaces or Bloch spheres are topologically related in the phase space. The invention according to the claim endorses a technology to manipulate the topology of phase space. The material structure and its dynamics are fundamentally different from quantum and classical mechanics known today.

<Description of the Features According to Claim 4>

The clocking jelly architecture of the invention according to claims 1-3, develops its own concept of processing the information related to mass, space and time from the topology of phase. Claim 4 is an essential part of the invention as it develops its own concept of physical parameters found in nature. In the conventional languages, a metaphoric word is used to represent scientific terms and phenomena. However, that is not possible in a geometric musical language, since, materials process the language. Current computers use human's metaphoric representations as is in its machine language. For the present invention, it is not possible. Materials have a fixed set of properties. We cannot change that. Therefore, the language intended to invent is bound to create everything that happens in nature, in its own way.

Topology of phase is only tool for the language. In the invention according to claim 4, only three parameters, mass, time and space are considered. The reason is that in the current science, one could represent any scientific parameter in terms of mass, space and time. This is called dimensional analysis. It is often used by scientists to verify equations. Now, since the topology of phase would replace the three parameters, mass, space and time, all physical parameters in the universe would be represented in terms of phase. Thus, clocking material for processing the geometric language would have its own unified protocol to process physical phenomena.

The material for processing the geometric musical language exhibits topological features. However, these are not conventional topological materials. The used materials for this invention are fractal in shape. The one to one correspondence between the shape of the material and their vibrational signature is a key. The language depends on the geometric pattern using which the vibrational frequencies are related by phase on a Bloch sphere. Change in phase path on the Bloch sphere surface keeping frequency points unchanged can change the event perception or meaning. All singularity points represent signal burst at particular frequencies If measured with a high resolution a clock is observed in the same frequency. The phase relations between a clock located inside a singularity and outside are related. Hence, topological features may edit even diameter of a Bloch sphere.

<Description of the Features According to Claim 5>

The clocking jelly architecture of the invention according to claims 1-4 shrinks a large amount of information such that if expanded following specific rules, the original information structure will be restore. The invention according to This particular claim, claim 4, uses a materials or hardware property that enables it to switch off clocks with repeating geometries except one. The repeating pattern and the clocking feature that enables repeating the unit pattern into a fully grown information is the seed pattern. A seed pattern's occupation of space could be orders lower than the original information architecture.

An information architecture is an integrated Bloch sphere network. From center of this architecture, one could project geometric information of clocks all around. Observers could read very different kinds of information from all around from the same information structure. This particular feature has multiple applications in shrinking a big data. The claim details usage of this feature.

Five major things could happen in the clocking time jelly. (i) One could reorient the clocks such that the information projection at a particular direction changes while it remains the same in all other directions. (ii) one could adjust several planes such that information projection remains the same in all the directions. (iii) Some planes or Bloch spheres could become redundant, an alternative simpler geometry could project the same information structure. (iv) Several planes of rotations or clocks could survive in a single Bloch sphere. These planes would generate several alternate complex phase paths in the same Hilbert space. (v) Fewer system points could generate similar projection. Thus, five 3D symmetry factors could reduce the giant information structure made of clocking Bloch spheres significantly.

The claim outlines two major factor that shrinks large data. Both are based on symmetry. Symmetry could lead to building a fractal seed by identifying self-similarity across a 2D space, or collapsing the information structure in a 3D space.

<Description of the Features According to Claim 6>

The clocking jelly architecture of the invention according to claims 1-5, acts as an universal sensor. Claim 6 outlines typical hardware features that enable the system to construct 3D clocking jelly architecture from a stream of 2D pulses. Different sensory signal produces different kinds of stream of pulses. Thus, the clocking jelly hardware has the ability to synthesize clocks by analyzing the phase relationships. Thus far, Fourier transform has been the most useful technological tool in the information processing industry. It, however, does not work here. It cannot build the time crystal based architecture. The foundation of clocking architecture is the periodic changes of phase associated with the resonance frequencies. Claim 6 addresses clocking transformation of a wave stream, which is fundamentally different than Fourier transform. Here, by converting one wave form into another only by changing phase within a finite time of applying a pulse. The time taken for wave transformation is the topological path traversed by the system point on the clocking sphere. Therefore, clocking transformation cannot be achieved using a pure mathematical formula like Fourier transformation. One has to do experiment to find the hidden phase transformation relations at the original source of the signal. Then, the surface of Bloch sphere network could be created.

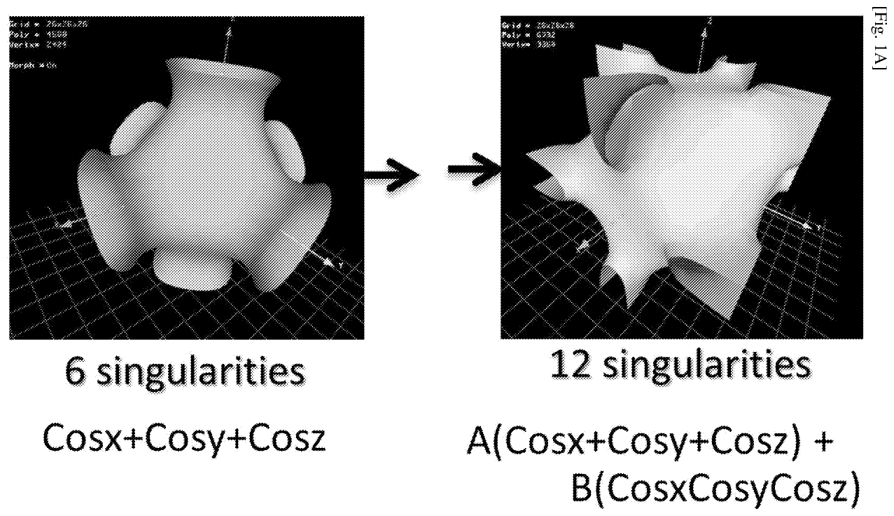

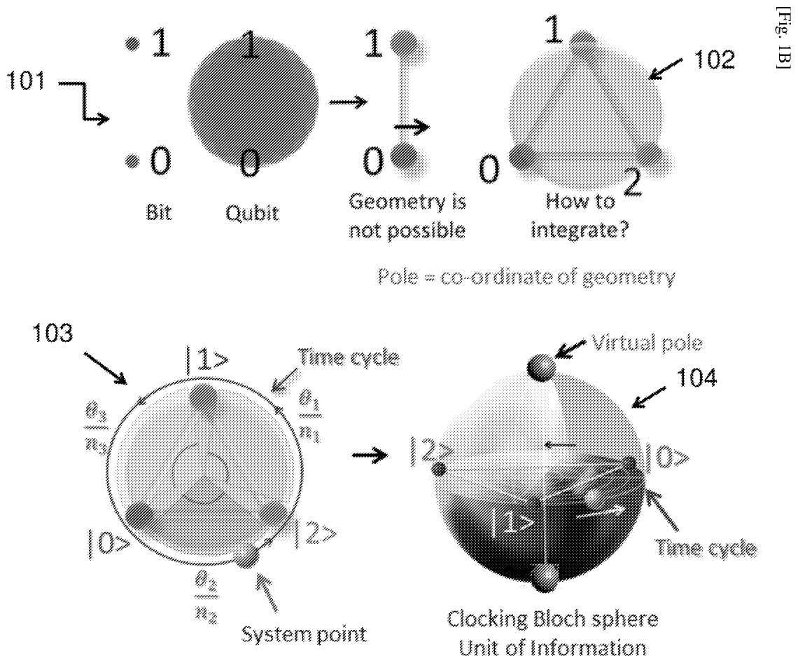

For the visual information, the density of peaks in a stream of pulses in an area for a given time width is used to draw a picture. The density of time fluctuation gives a spatial picture. Now, by setting different time width of pulses, one gets different pictures. In the stream of 3D columnar pulses the periodicity along X, Y and Z axes varies as Cos x, Cos y, and Cos z. Together, they follow the function Cos x+Cos y+Cos z. This function has eight singularity points. This is similar to E8 symmetry of Lie Alzebra [non-patent document 10]. See FIG. 1A. For the present invention, eight different pictures are created. Three cosine functions while editing phase could provide eight distinct parameters to split one image into eight parts. One Bloch sphere gets eight singularity points. The guest Bloch spheres embedded inside the singularity points could change structures to hold all eight images simultaneously. Note that 12 waveforms superimpose to create 8 singularity points.

All sensory systems make time crystals like the visual signal described above. However, for each sensor, a particular parameter is used to group discrete pulses. For auditory stream of pulses, the time window that we slice from input plays primary role in grouping and creating eight layers. For visual signals, spatial density of peaks make the eight layers distinct. For taste, the composition of areas decide layers. Three variables, the weighted average of intensity and areas affected by elementary states make a 3D structure. Here the primary controlling factor is the set of relative areas. For touch, invisible distances between surfaces hold the key information. For smell, geometric identity is important. This is only sensor that directly uses the grammar of topology, like 1D, 2D, or 3D geometric shapes as memory.

To construct the sentences, none of the sensory information derived time crystal is left out. All of them are integrated simultaneously. Geometric musical information does not classify crystals. Five sensors isolate information with a distinct topology. However, they make similar kinds of time crystals, visual (spatial density pattern of fluctuations), auditory (dimension of time window), taste (relative area), touch (distance between planes), smell (geometric shape).

<Description of the Features According to Claim 7>

The invention according to the final claim, claim 7, addresses the hardware features essential for processing a geometric musical language. The invention is based on experimental discoveries of this language in microtubule. Then, it was replicated in artificial synthetic organic molecule. Finally, in equivalent electronic devices and systems, claim 7 does not favor any particular hardware. It articulates common features to the language processing hardware of any kind.

The elementary device used in the present invention is a typical oscillator. It could be classical or quantum. The geometric phase of the device changes in a clocking manner in a quantum oscillator. However, for the sake of geometric musical language, during a periodic oscillation of geometric phase, there would be another clock. As the system point encounters the guest clock, another geometric phase starts counting. This feature is absent in quantum oscillator. We name new oscillator as fractal oscillator.

The elementary device acting as a fractal oscillator should have a rapidly oscillating membrane. If the boundary oscillates rapidly, the quantum effects are possible at room temperature, ambient atmosphere. This is shown in previous 2D cavity resonator studies. We use this technology in the current invention for a 3D membrane. Since membrane is used alone, the cavity inside remains empty. The claim endorses to use this entire empty space to fill with other cavity resonators. This engineering feature ensures that (i) boundary conditions of guest and host clocks matches. It means, the slower clocks represented by the larger, host membrane and its guest clocks represented by faster, smaller cavities vibrate in a fixed phase relation. (ii) Nesting of clocks via fractal assembly of clocks becomes possible. (iii) All membranes are kept porous to leak carriers. Normally, leaking is considered bad. Here, it is good. Leaking helps in harvesting energy from noise, adjusting the resonating waveform to stabilize by itself. Use of membrane alone enables cavity resonators to pack in an extremely dense manner.

Apart from rapidly oscillating porous membrane, the hardware needs to store geometric shape in the singularity points. The guest cavities arrange following periodicities described in claim 6 for all three axes. The phase change of resonance frequencies of such a cluster generates 8 domains where the variation of phase disappears. This is the definition of singularity. Topological parameters of the assembly like (i) lattice parameters, (ii) diameter of elementary cavities and (iii) engineered fault lines are three parameters that control the domain of singularity in the assembly of fractal oscillators. By adjusting length, pitch and diameter (X, Y Z axes) at three layers one inside another, the elementary nested clock device is made.

### Preferred Embodiment of Invention

FIG. 1B explains the basic information structure in the existing information theory. The concept of a “bit” (101) is a two distinct classical state system. One is independent of the other. “Qubit” is a similar concept (101, middle), except that the two classical states reside on an imaginary sphere that holds infinite possible paths to make journey, one point to another. The spherical surface could be said a Bloch sphere and all points on its surface make a set called Hilbert space. Also, the spherical surface could be said a phase space. As if, phase change takes a system point one from one classical pole to another. Both “bit” and “Qubit” are tagged as information, but holds no information in it. To encode topological information, a triangle is added to bit or Qubit, they become Qutrit (102). There exists a generic concept of Qudit, or classically, multi-level switch that incorporates several states, but no proposal existed for holding a geometric shape information as noted in 102.

Addition of a geometric shape alone is not sufficient to create an unit of information that alone makes decision, stores memory, holds data for an event using only topology. Therefore, further changes were made. A close loop is added to the Bloch sphere, and the corners of the geometric shape reside on the loop. Then a clock or time cycle is added (103). Time cycle or clock is an event of change in phase by 360°. Therefore, the basic parameter in the modified unit of information is phase. The panel 103 is the cross section of panel 104, where the final unit of information is noted. The modified Bloch sphere of 104 points out one fundamental difference with the Bloch sphere of conventional Quantum mechanics. The poles are not classical, the poles do not exist, but a virtual point could be imagined around the axis of rotation of the clocks.

Two reminders. First, the phase loop could hold any geometric shape. There is no need to consider that it should always be triangle. The geometric shape held by the loops could be a 1D geometry, or 2D or even 3D structure. Second, a mistake could happen that the invention suggests forming a great circle or only circular loop. The Bloch sphere may not be a sphere as often the case in a Qudit. At the same time the loop that phase evolution follows to create “time” or clock could have any topology.

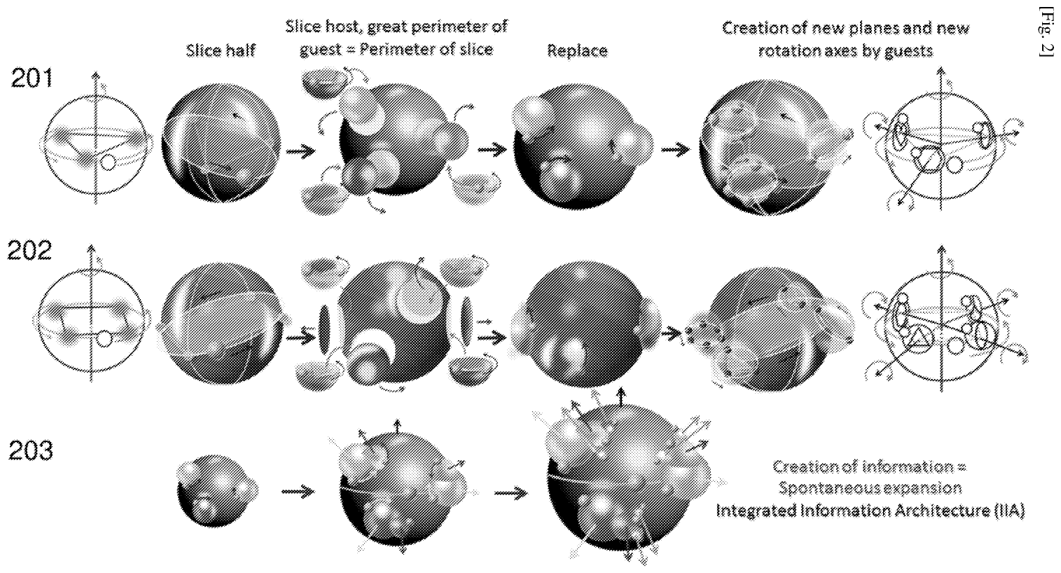

FIG. 2 explains how information is integrated. Here two examples are shown. In the first example (201) the clocking Bloch sphere holds a triangle. While in the second example (202) the clocking Bloch sphere holds a square. To integrate information, the spherical surface is sliced off around the corner point of the geometric shape, where it touches the sphere or the loop of the clock. One could notice three sections of 201 and four sections of 202 are sliced off. The cut off regions are replaced by parts of a new Bloch spheres that holds their own distinct geometric shapes embedded in their own clocks. Now, in the right most panel of 201 and 202, the new rotational axes of clocks are shown. Since the rotational axes are perpendicular to the plane made by clocking loop, the density of added Bloch spheres is maximum around the great circle only.

This process of expansion continues (203).

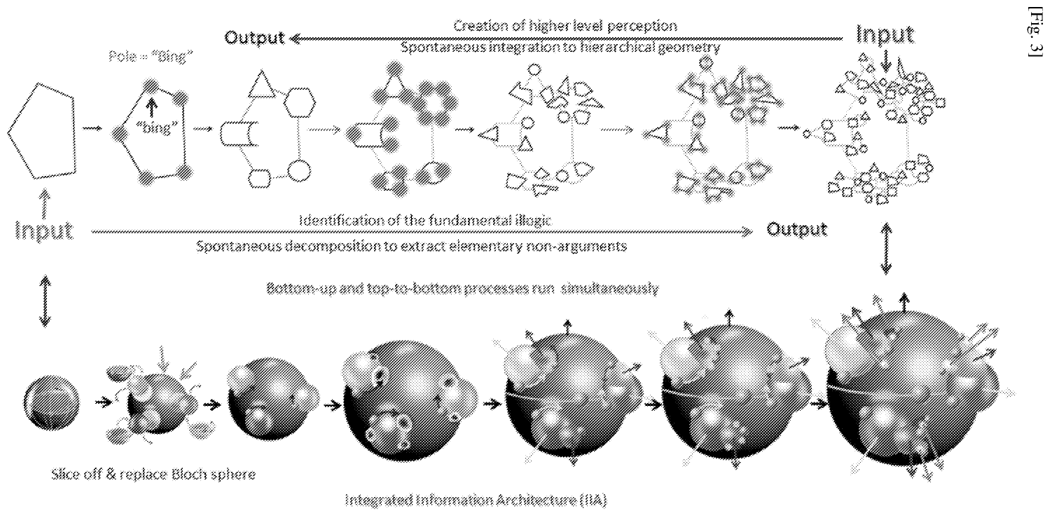

In FIG. 3, one to one correspondence between the geometric shapes and the corresponding integrated information architecture (IIA) is shown. The integrated information architecture is a self-assembly of Bloch spheres. In the FIG. 3, in the top row, a pentagon is drawn in the modified Bloch sphere. The five corners of the pentagon are five singularity points. They hold geometric shapes inside. Then, each corner of those geometric shapes acts as a singularity point and holds a geometric shape inside. The process continues. Similarly, in the lower row, Bloch spheres are continuously sliced off at the corner points and new Bloch spheres are added.

The lower row of FIG. 3 also shows that the whole architectures expand continuously. This is because when one puts many guest spheres side by side on a single host sphere, then, several spheres may come nearer. Eventually, it would collide. This would destroy the purity of information, totally. This is why the hosts are expanded keeping the relative phase relations intact.

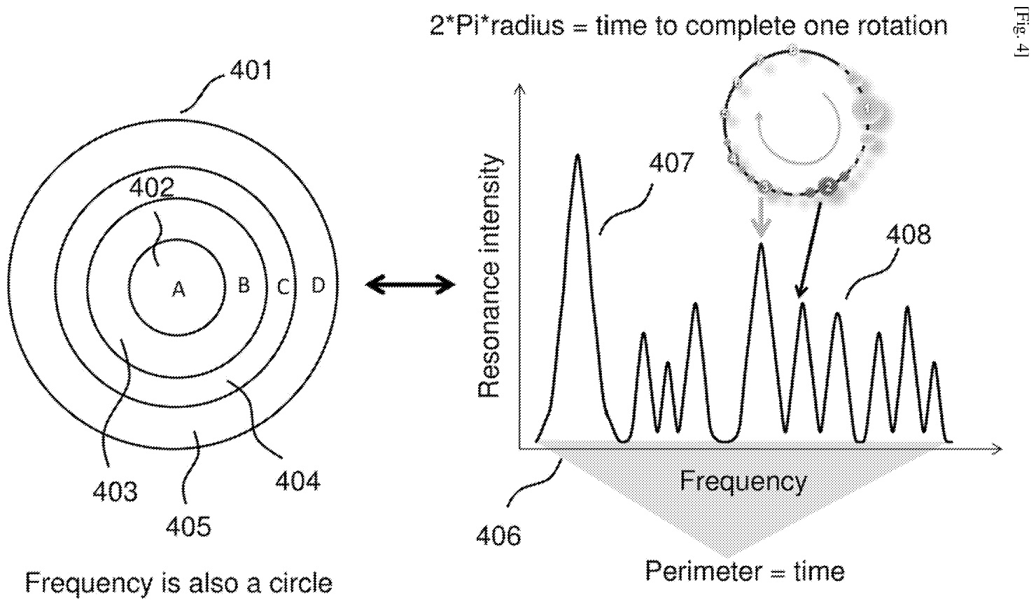

FIG. 4 explains intimacy of phase and frequency in the material that exhibits similar information processing. The nested clocks of FIG. 3 are shown as concentric circles in 401-405. During an automatic self-assembly of clocking cavity resonators whose Bloch spheres are shown in FIG. 1B, FIG. 2 and FIG. 3, the growth is bottom up. When the structure A 401 having a frequency band 402 undergoes self-assembly process to create the next structure B 403 which has the fractal frequency band 404 that occupies a region of frequency band of the seed structure. The next frequency band also will be a part of its starting structure and thus the process continues.

In the classical information theory, by Fourier transformation, the stream of pulses randomly propagating through the device is measured and transformed from the time domain to the frequency domain as shown in 406-407. In the quantum information, a generic idea is given. For example, in the frequency spectrum shown in the graph of FIG. 4 406-407, one would find ten Bloch spheres, one corresponding to each resonance peak. Here, all ten clocks could have groups of 3D phase relationships. And those groups would combine into another Bloch sphere whose great circle perimeter is denoted as 408. The entire process of assembling groups of frequencies into a larger Bloch sphere continues, until one reaches to one single Bloch sphere. The eventual information structure would look like one shown in FIG. 3. The hierarchical topological integration of frequencies is the key of this new information theory.

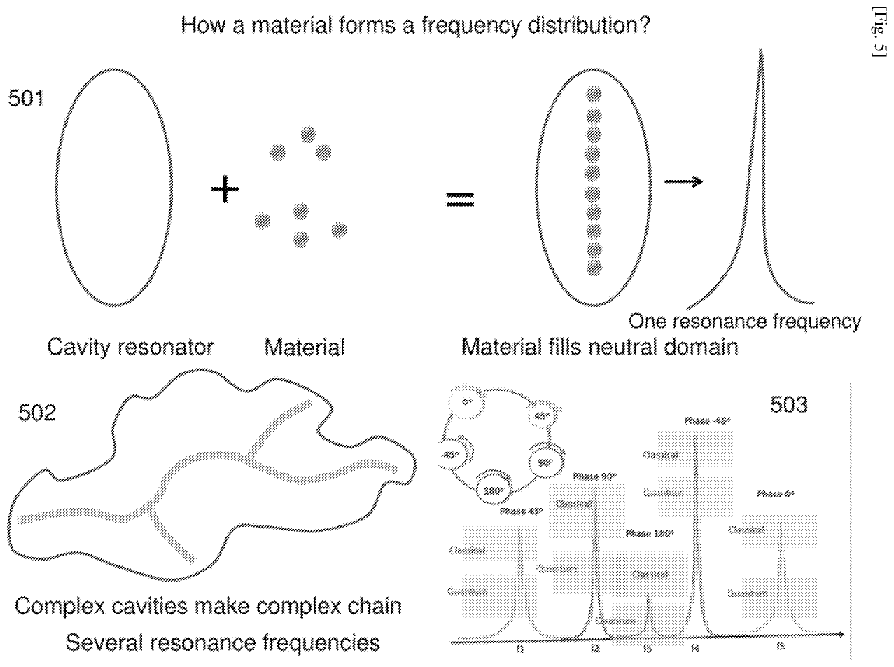

The basic structural feature of the material that processes geometric musical language (GML) is described in FIG. 5. How a membrane of a cavity or the physical external boundary of a cavity turns to a clock?

Any cavity cannot produce cyclic vibrations or rhythms; a cavity requires a particular composition of cavities inside. The compositions of cavities are such that as a whole the system acts as a harmonic oscillator energy transfer among the constituent oscillators cycles in a loop. All constituent cavities exchange energy with their neighbors as synchronized local groups following a strict time period, as a result, an energy packet moves from a set of cavities to another inside the same host cavity. This is how a cavity resonator operates; the rhythmic cycle of a cavity resonator is not produced by its cavity membrane vibration, rather, by its constituent cavities inside. Membrane of a cavity is always the most active center as it primarily exchanges energy with its neighbors to define the cyclic oscillation of its host cavity, above, then it has its own natural vibrations. Finally, the third component, the same membrane acts as a host for its guest cavities inside who define its vibrations too. Therefore, vibrations of a membrane if measured from another cavity resonator system gets perturbed by its host, its own properties and its guests inside along with the cavity resonator network by the system.

Majority of cavity resonators are self-similar as multiple cavities self-assemble to create the cavity resonator of a larger spatial scale. In order to account for neighbors, a fractal function f(z) is essential to represent even a single cavity resonator. However, it should be noted that the imaginary part of each cavity resonator is different, imaginary parts may contribute to the real part of the measurement, however, all imaginary parts cannot mix. Imaginary part of a cavity under consideration does change via other imaginary parts f{f(z)}. However, imaginary part is an imaginary function of other parts. Hence, the imaginary parts change too as a function of time.

In the basic architecture of the elementary material in different layers the resonance frequency domain differs widely and therefore a little change in structure arrangement can bring a complete dissimilar frequency band patterns. Thus a shift from structure 501 to 502 the corresponding output frequency band patterns 503 is changed to widely different distributions. 503 also outlines the phase associated with each peak. Note that experimentally, the value of frequency and the value of phase alone cannot allow one to plot the 3D Bloch sphere architecture shown in FIG. 3. One has to switch the material to resonate from one frequency to another. During transition of resonance frequency, one can determine how the phase is changing. Several tracks of phase change provide lines on the Bloch sphere. Thus, one could experimentally derive the Bloch sphere based information architecture.

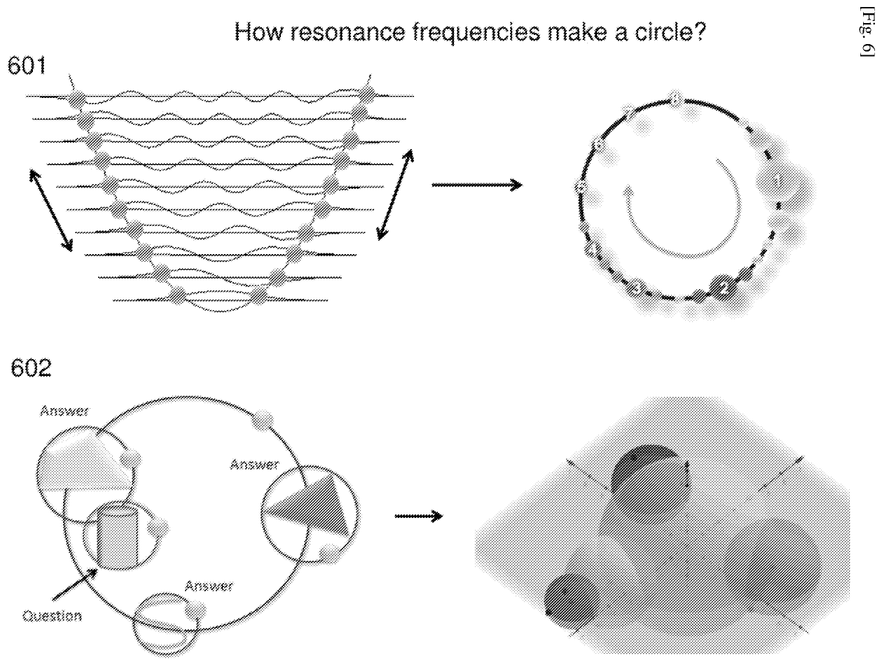

FIG. 6 shows how even a 1D potential well, e.g. a single atom could have several harmonics and those harmonics if plotted as group of guest clocks on a host clock would represent only one point (601). It means, for implementing the current information theory in experimental material, one should not concentrate on the harmonics of a fundamental frequency. All corners of a geometric shape should have a fundamental frequency. If one is harmonic of another, then, activation of a material would trigger several wrong geometries in the material. The expression of the geometric musical language (GML) would be erroneous.

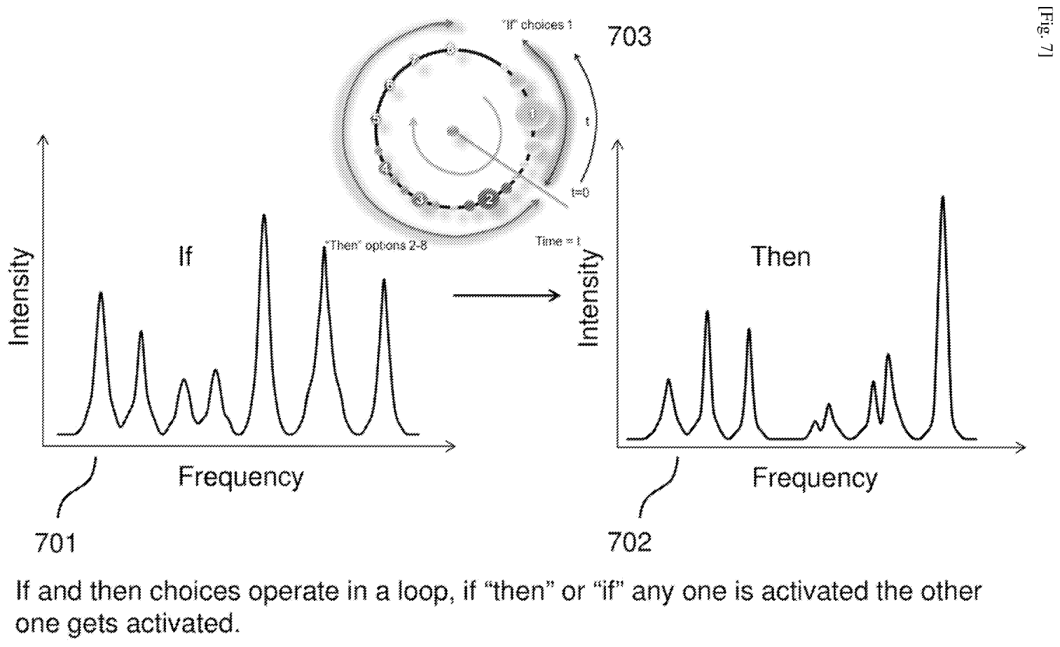

602 shows how exactly geometric musical language stores a decision. Here, on a single clock, three guest clocks, each holding a typical geometric shape are placed. Even one of the guest clock acts as a host for another clock that holds a 3D geometric shape. To its right, the equivalent 3D time crystal architecture is shown. This structure could act as decision making. Schematic presentation of FIG. 7 shows the Fourier transform of two geometric shapes located on a single clock. If 701 is triggered, then the answer comes from 702 and vice versa. For 602, if the question is 3D cylinder, then several new queries would be born at slower clocks above it. This technology is important. If one puts eight geometric shapes in eight clocks as guests on a slower clock, even if questions are asked 8\hat{ }8˜16777217 ways, the simple structure would always give the right answer. If one considers that one of the eight guest clocks have 8 guest clocks inside then the system could correctly answer 8\hat{ }8\hat{ }8 query. This is how the power increases for this geometric musical language.

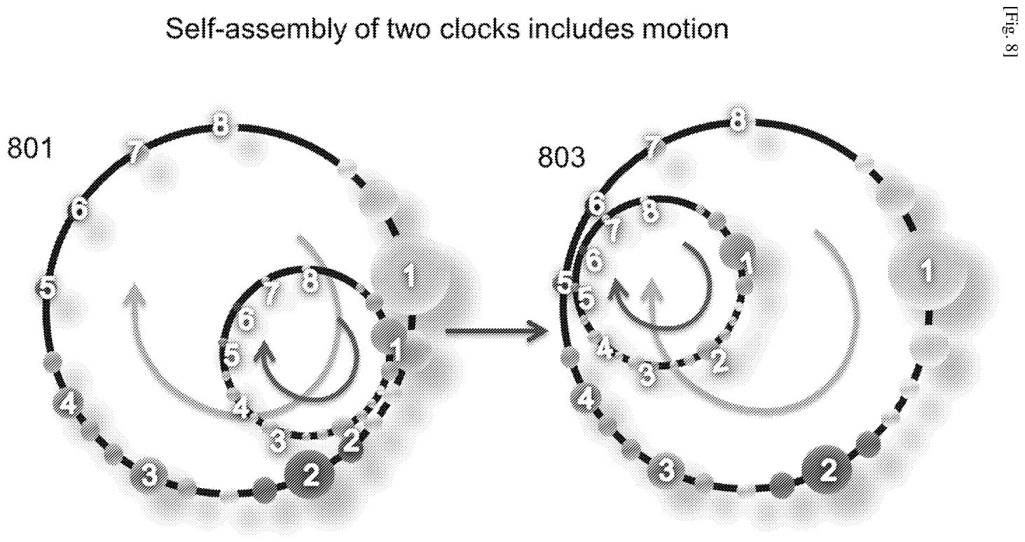

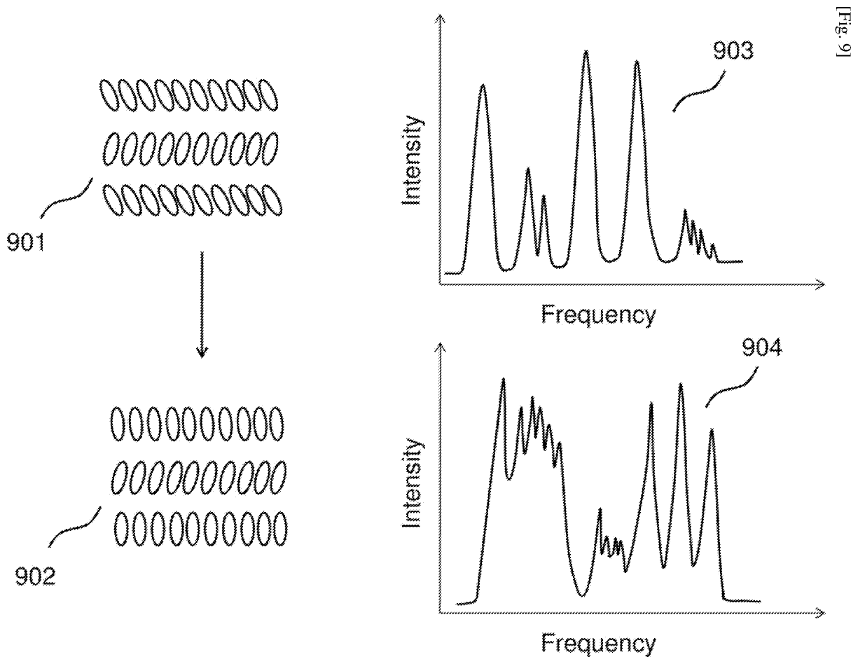

FIG. 8 explains self-assembly of a pair of clocks. This can happen in various ways. In the subsequent figures, various modes of self-assembly are described. 801 and 803 are two steps how one clock is rotating inside another by touching the common frequency points. 901 and 902 in FIG. 9 are two materials, with a little change in the ordering of its components or symmetry. The corresponding resonant bands 903 and 904 show a fundamental change in the resonance pattern due to the change in the symmetry.

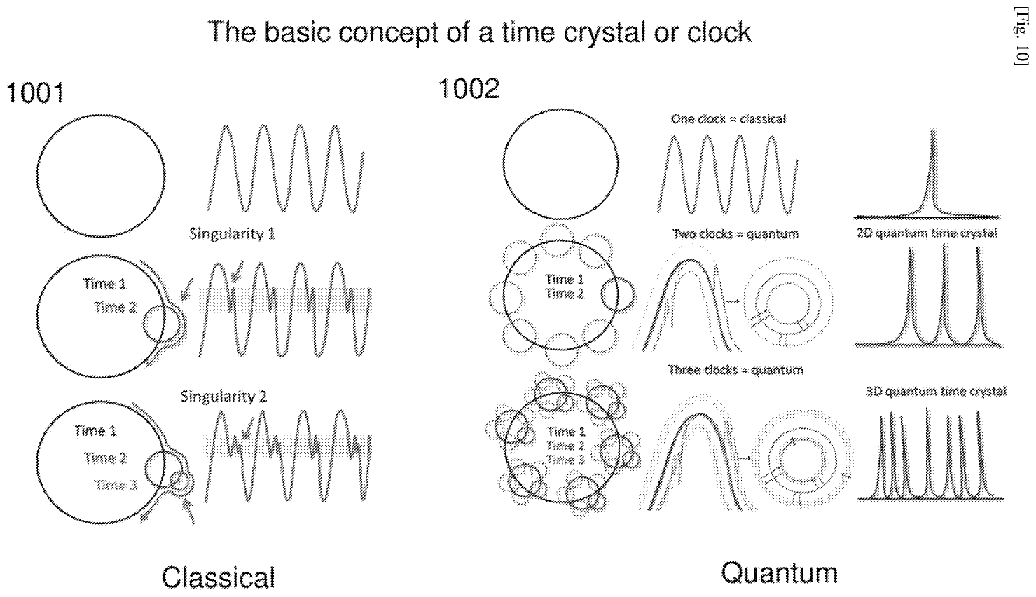

One to one correspondence between the clock and their corresponding signal output is described in the FIG. 10. Here 1001 describes classical nesting of clocks and 1002 describes quantum nesting of clocks. From top to bottom, three panels of 1001 show what happens to the output waveform when one guest appears on the host (middle) and the guest gets another guest (bottom). There is only one system point. In 1002, there are three columns shown. The first column shows when one guest clock nests with the host clock, how the output would change (middle row). The bottom row shows if the guest clock gets a guest clock of its own, quantum mechanically, what happens to the output. Getting a guest clock quantum mechanically means the time cycle could exist anywhere on the host. Note that entire nested clock system cannot be pure quantum, because, if all clocks are uncertain, then there is no clock. Therefore, the main clock is classical. On that certain clock we nest a quantum clock for a feasible analysis. When the guest quantum clock resides everywhere on the host clock, we get three wave forms in quantum. In classical nesting of clocks, there used to be a kink of disturbance in the resultant waveform. In quantum, there is a split in the clocks and three waveforms are detected. In the frequency spectrum three peaks are observed along with many peaks in between. When the guest clocks get their quantum guest clock then, one gets seven prime peaks.

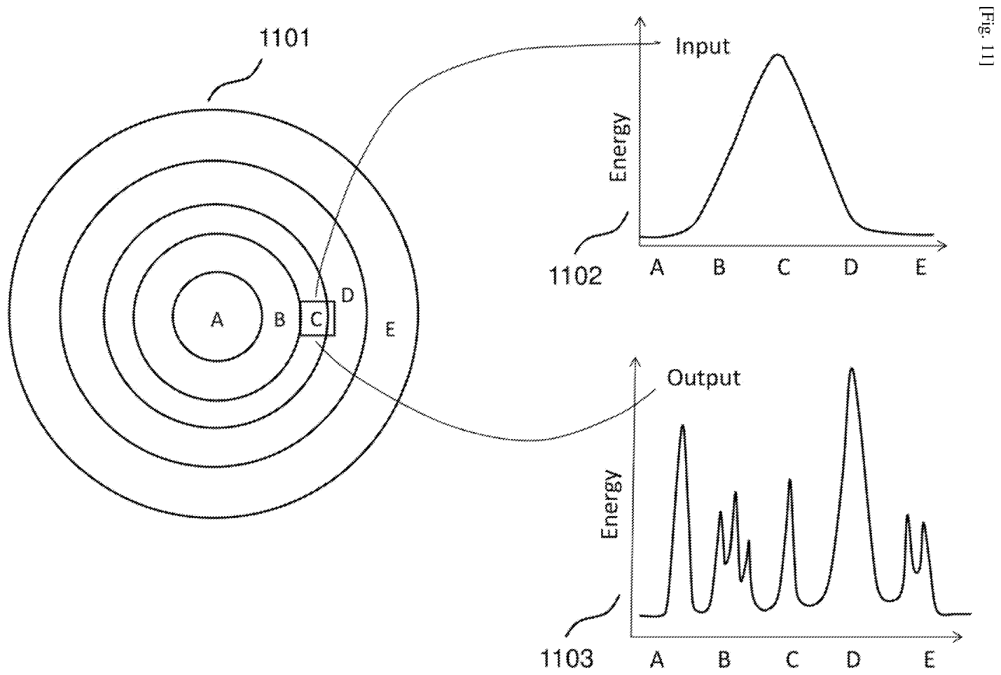

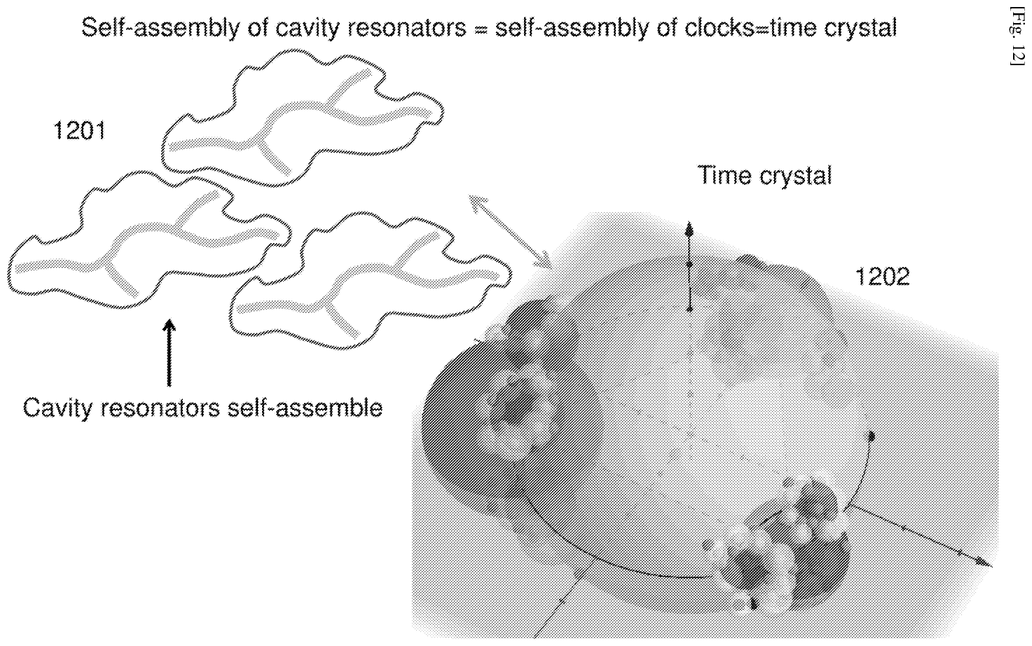

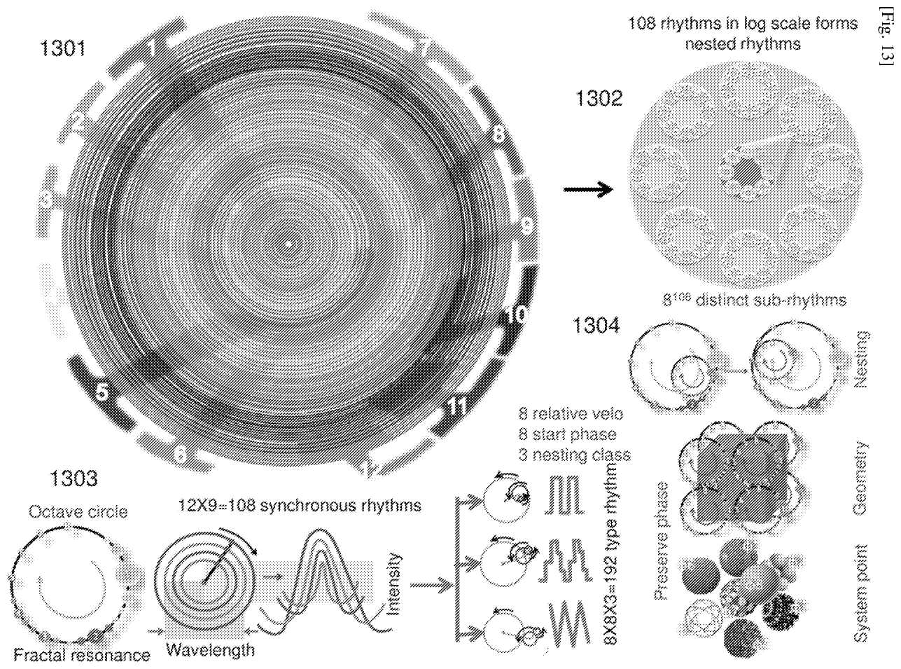

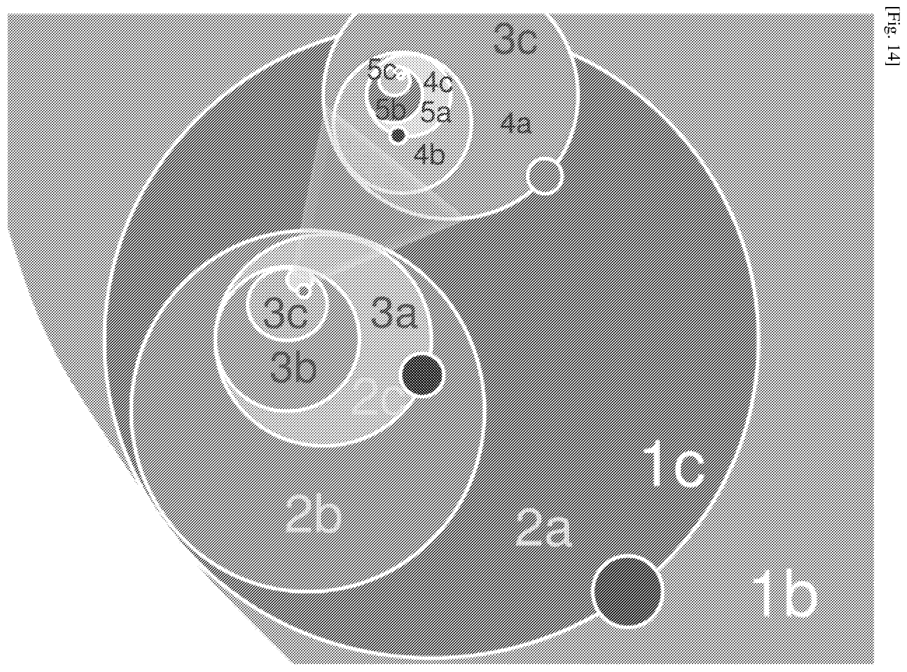

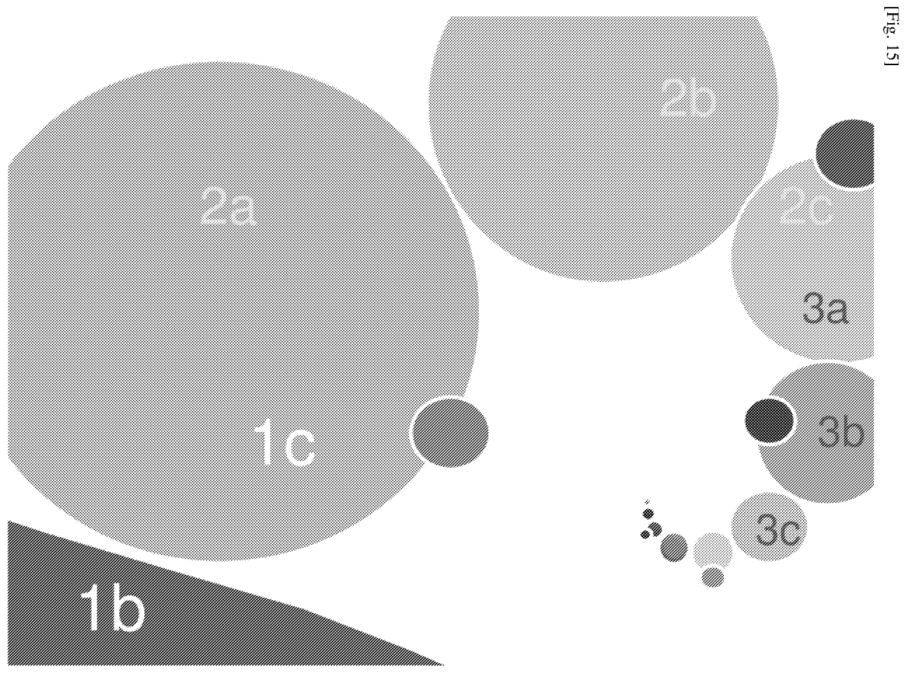

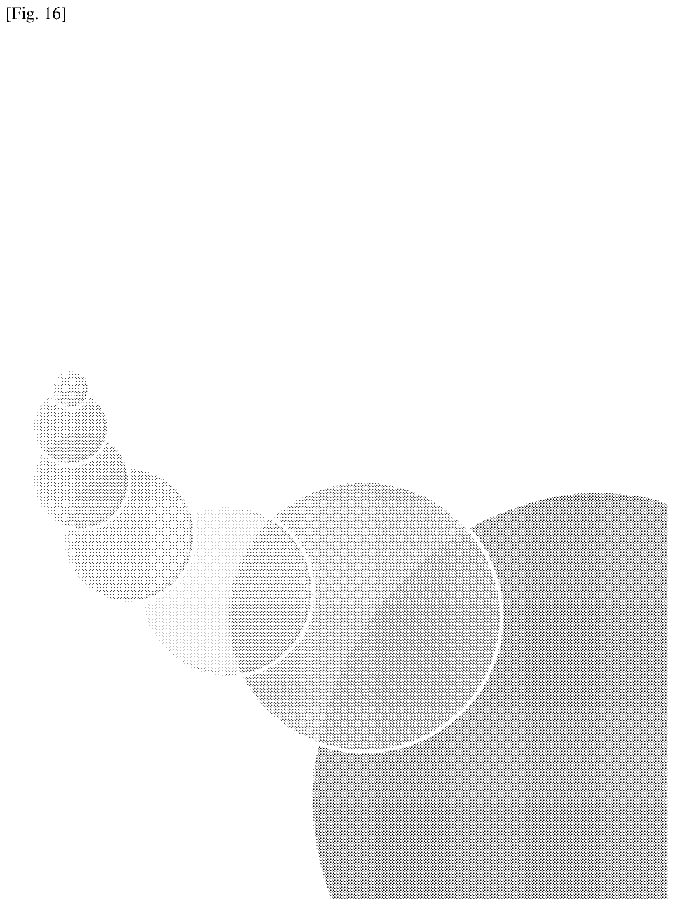

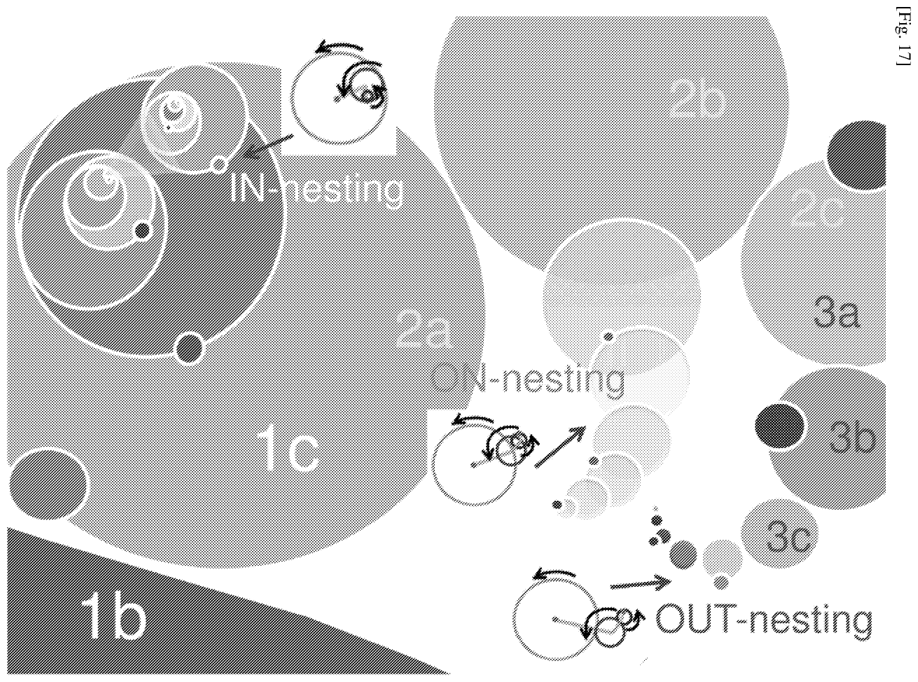

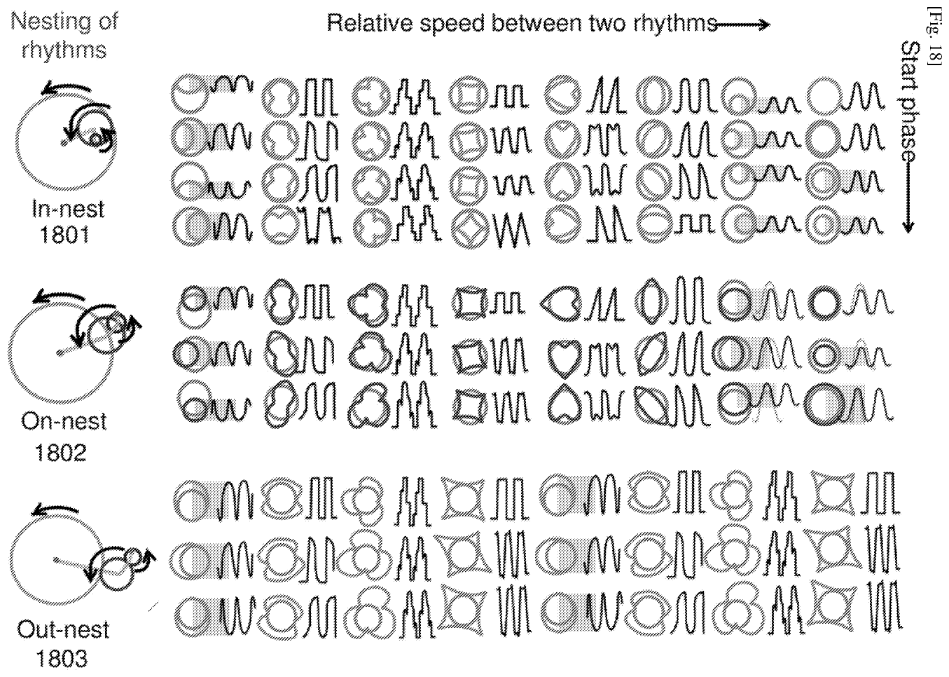

In the material structure 1101, where several clocks are nested with each other, as shown in the FIG. 11, the right layer (here C) absorbs the input 1102 and produces the entire time crystal. Therefore, a little association could retrieve entire information. An example of such an assembly is shown in 1201 and its corresponding time crystal is shown in 1202 in FIG. 12. Concentric representation of circles as clocks (1301), subset representation of the nested clocks (1302) shown in FIG. 13 are equivalent to the time crystal representation of 1202. The grouping of the clocks could be at various levels. A set of 12 groups (1301) could have triplet of triplet grouping, making 108 clocks as a prime controller of entire language processing material. The resultant time crystals (1302) would all have a similar basic architecture. 1303 also shown in FIG. 13 shows that during an assembly of time crystals if there are 8 relative velocities of the system points representing the clocks, and 8 unique starting phase difference, then 3 kinds of self-assembly could generate 8×8×3=192 types of clocks that govern entire systems expression of information. Three types of nesting are explained in FIG. 14 (in-nesting), FIG. 15 (out-nesting) and FIG. 16 (on-nesting). All three types of nesting actually act together to nest clocks as shown in FIG. 17. The output of in-nesting is shown in 1801, the output of on-nesting is shown in 1802 and the output of out-nesting is shown in 1803 in FIG. 18.

In FIG. 18, 80 different symmetries of time crystals are shown out of 192 maximum possible ways. Because of C2 symmetry half of total possibilities are considered. These classical time crystals are sufficient to provide a picture of the information processing architecture and their possible output in the system.

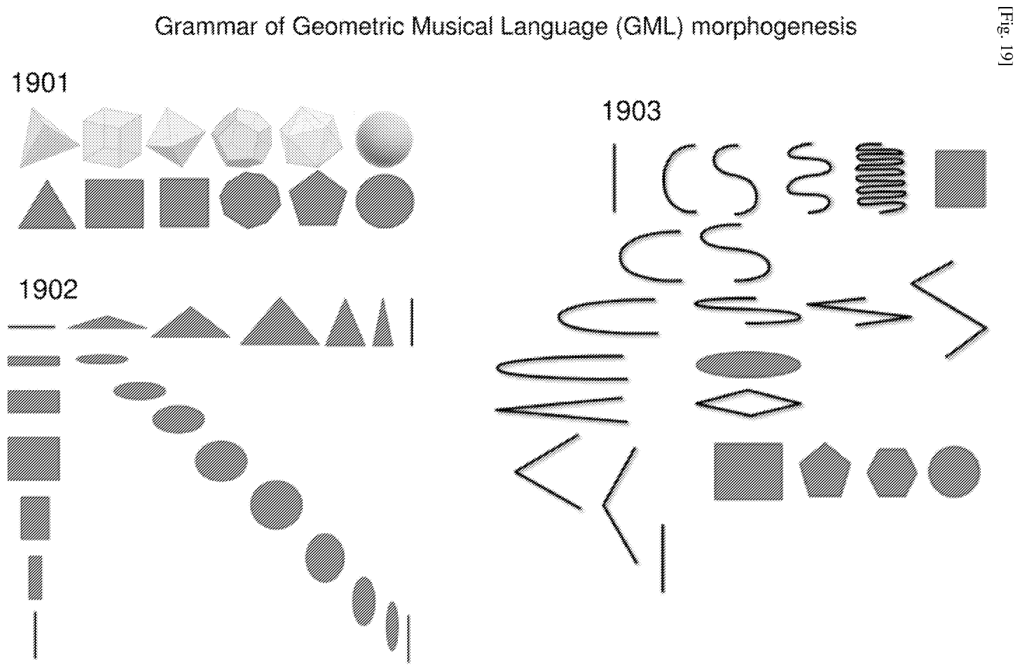

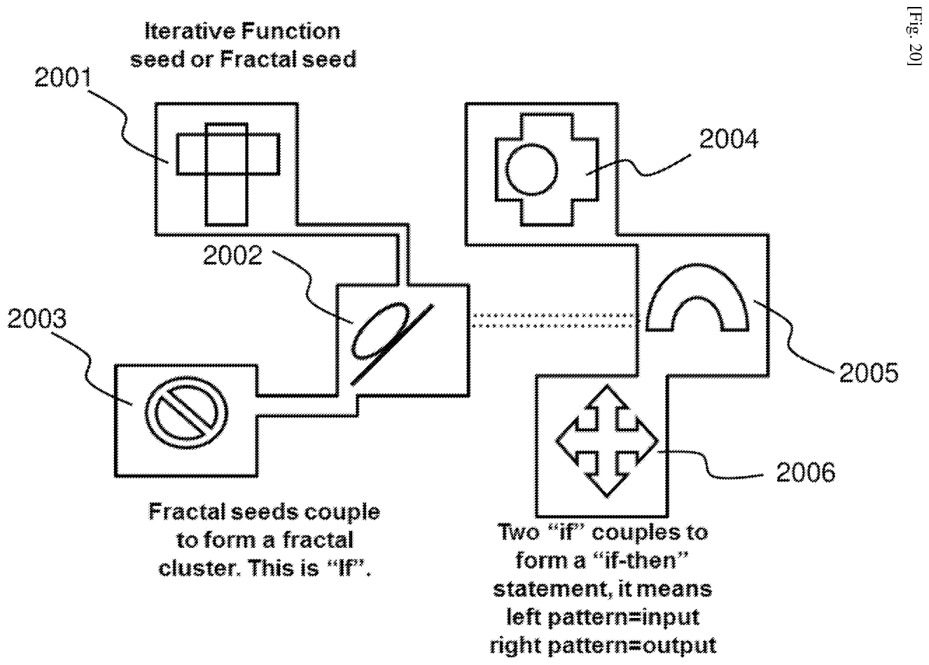

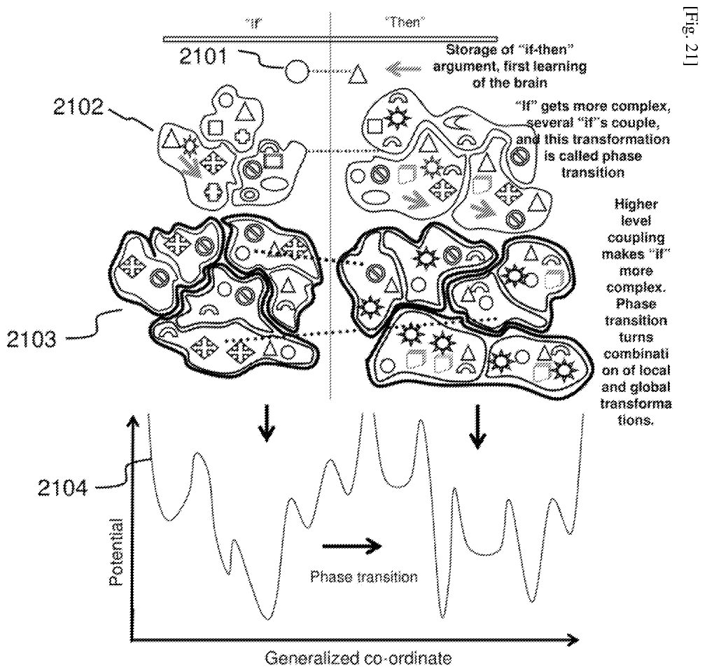

Every language has letters to construct their sentences. So does geometric musical language (GML). Unlike human languages, here, letters are not static. These are morphing geometries as shown in FIG. 19. Three examples are shown, where 2D and 3D structures interchange (1901), 1D lines and the 2D shapes interchange (1902) and finally, lines and the 2D shapes interchange (1903). During the processing of language, these geometric shapes overlap and form interchanging groups. It means there is a higher level morphing also between sentences, not just the words in this language (2001 in FIG. 20). These higher level morphing could go to the top level (2103 in FIG. 21) from the lowest single geometric shape (2101 also in FIG. 21). The hardware representation is switching of the resonance band. However, in the time crystal there are only changes in the singularity points. The main architecture remains the same, only the relative positions of the nested sphere move relative to each other. Therefore an information processing time crystal would have continuously oscillating spheres classically, and quantum mechanically, they could be located at two very nearby locations. In general an observer would find minor changes globally.

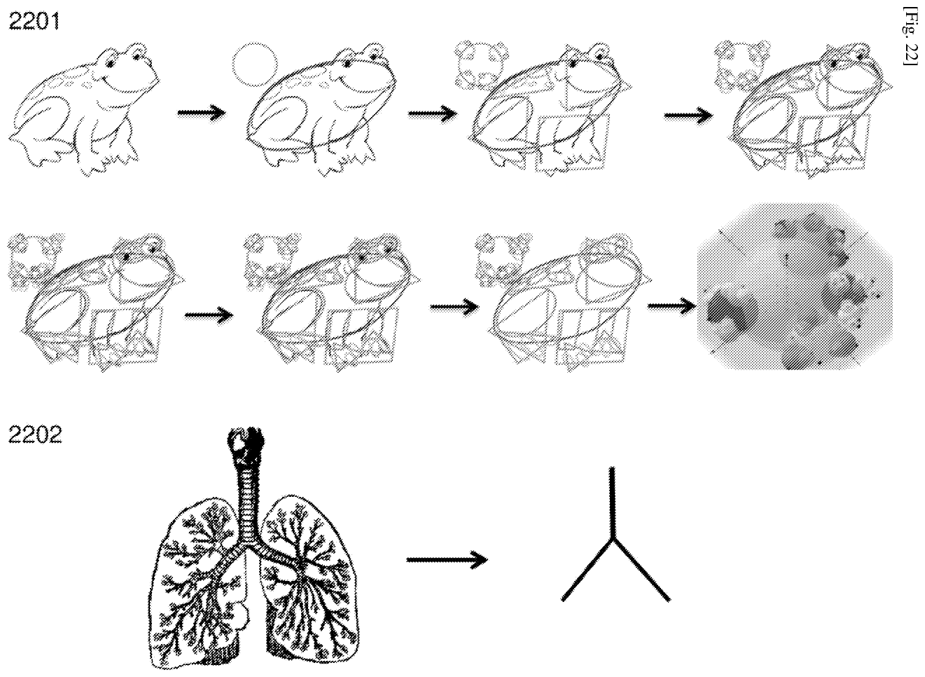

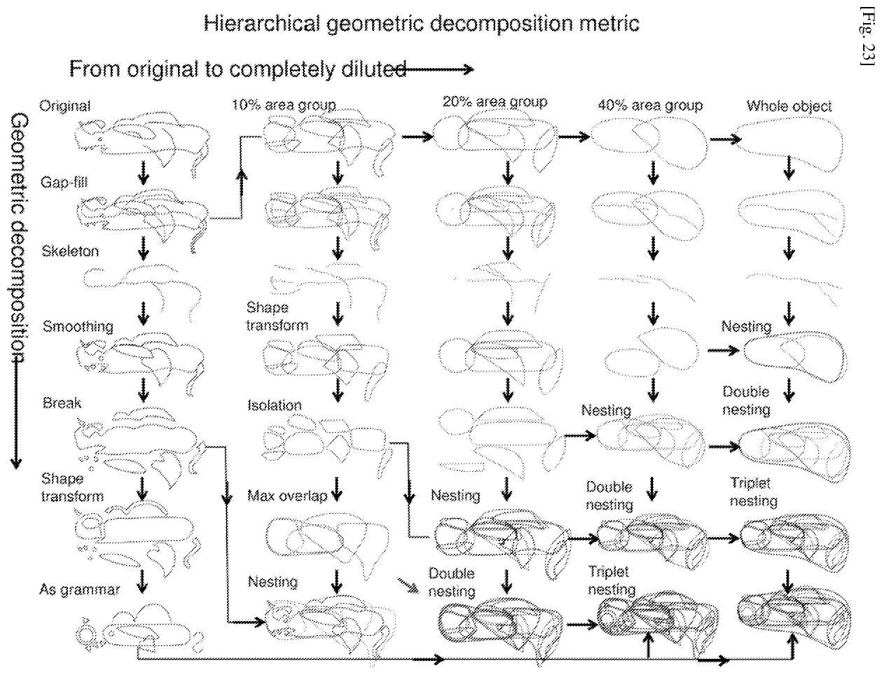

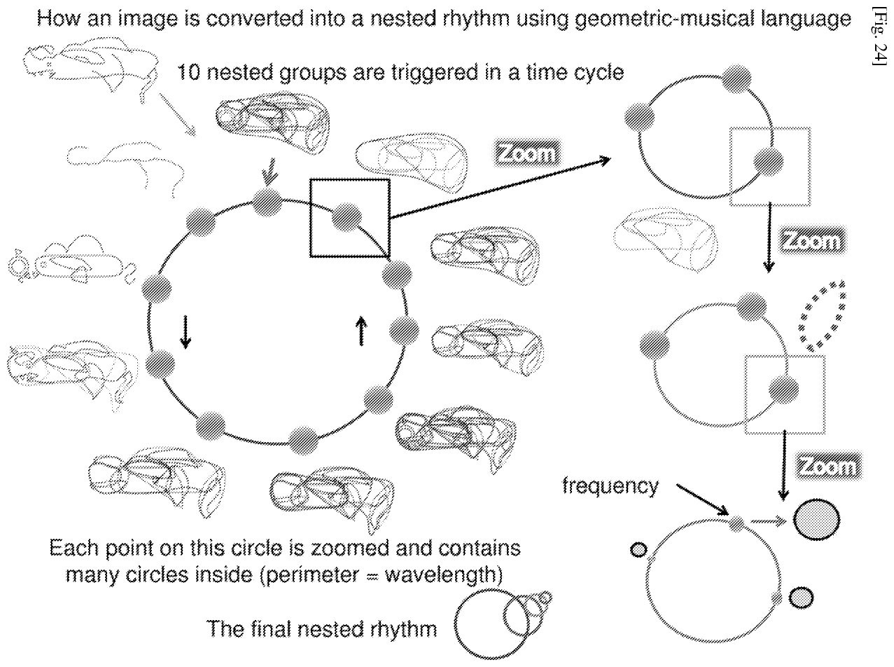

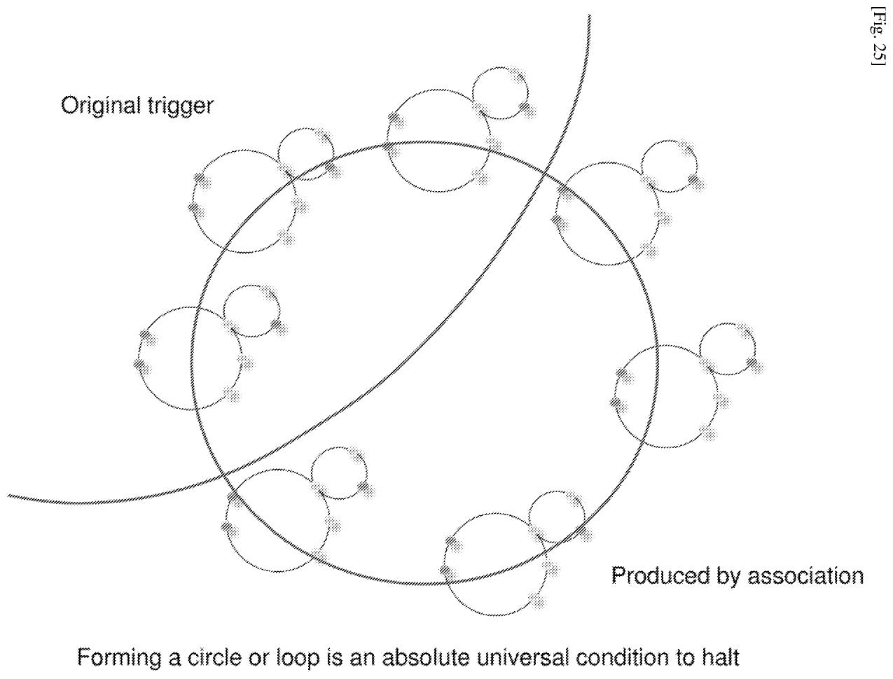

FIGS. 22 and 23 outline how a real image is processed in the geometric musical language (GML). FIG. 22 shows how a frog is converted into a time crystal, just following the rule described in FIG. 3. However, an ideal situation is not what is observed in the hardware. In FIG. 23, the image is a mixture of two animals. 5×7=35 image matrix shows how exactly a fusion of elephant and rat looks like. An image is normally disintegrated at various levels as shown in the FIG. 3. However, most situations are not an ideal one. Let us take, as an example, the elerat (elephant and rat) case shown in FIG. 23. Here, such a matrix conversion is part of natural isolating of geometric shapes and identification of core dynamic axis (third row, skeleton). In FIG. 22, an arrow is directed to demonstrate that when the cavity resonator network when oscillates then, they may switch to different dynamics spontaneously if they need to change the information content. There is no distinct time space location of the matrix elements. The elerat clocking of FIG. 22 is demonstrated in FIG. 24. During this process, each of the repeating structures gets only one occurrence. The example is shown in 2202 in FIG. 22. Here, entire lungs would be represented by a linear pattern Y. When Y is repeated, or clocks start moving or rotating, entire lungs would be played out. The triggering of associated clocks during this fractal enlargement process is shown in FIG. 25. Here, we find that the slowest clock holding the largest dimension is set even before the fastest clocks start running.

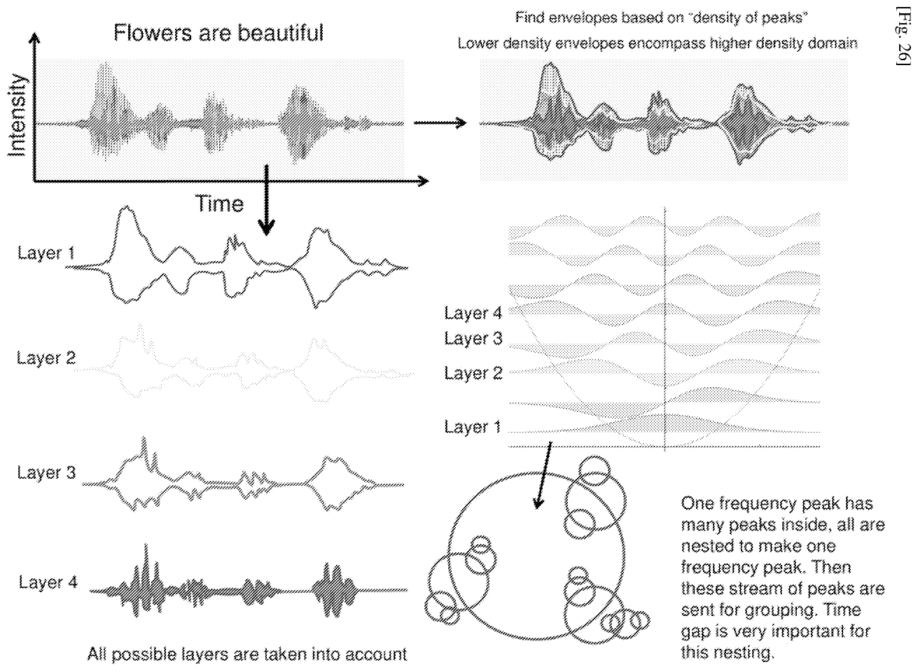

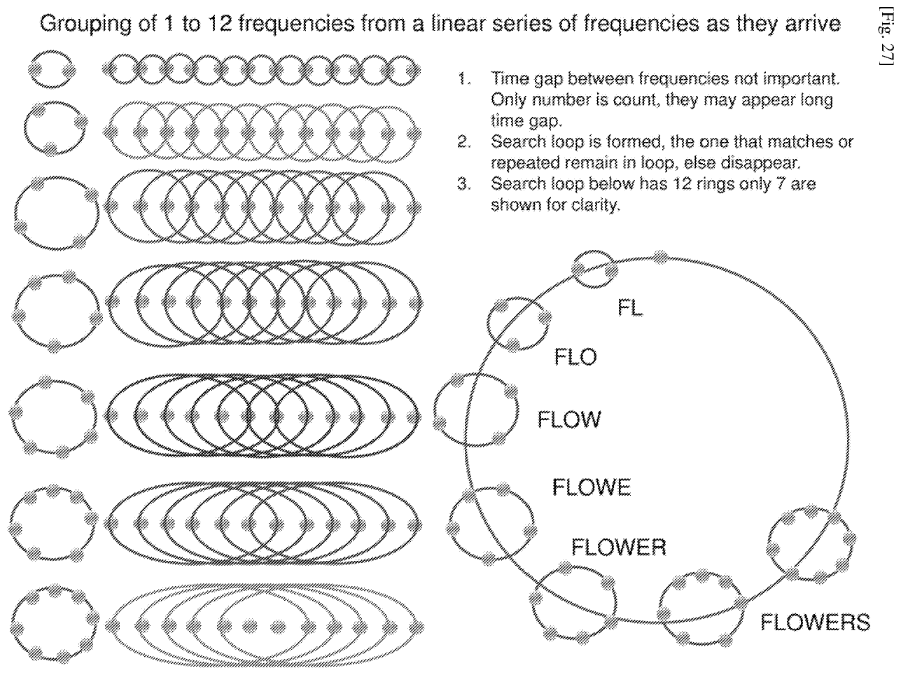

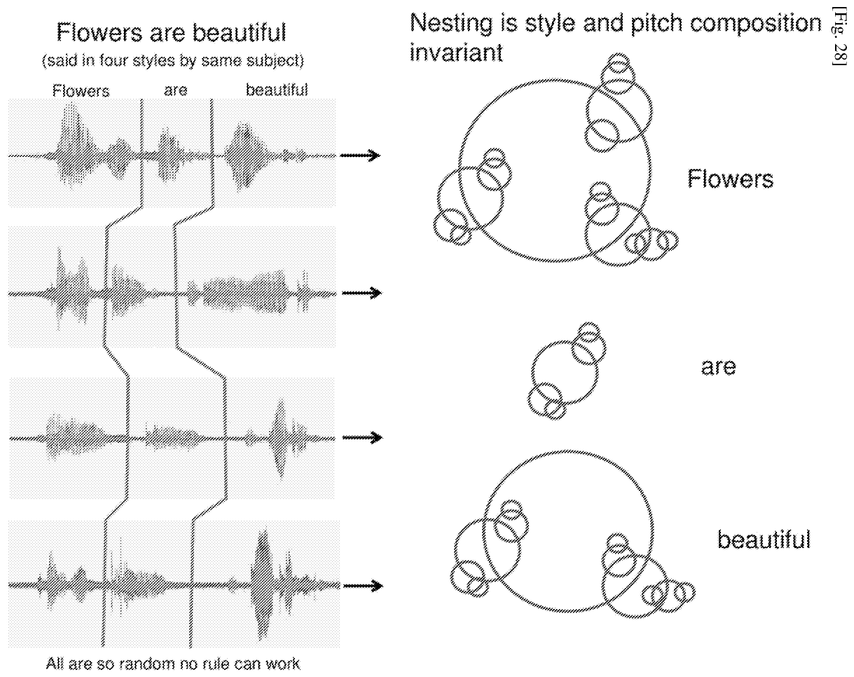

FIG. 26 explains the processing of sound signals by the geometric musical language (GML). First, the sound file (“flowers are beautiful”) is played and at different layers, groups of different resolutions are captured. Then from the intricate differences in the intensity-time profile between neighboring two layers, we get the map of clocks. Once the groups are identified, several time lengths of groups are made into distinct clocks (FIG. 27). This step enables the time crystal to filter out any word or specialized notations. Finally, the meaningful clocks are isolated and nested as integrated clocks (FIG. 28).

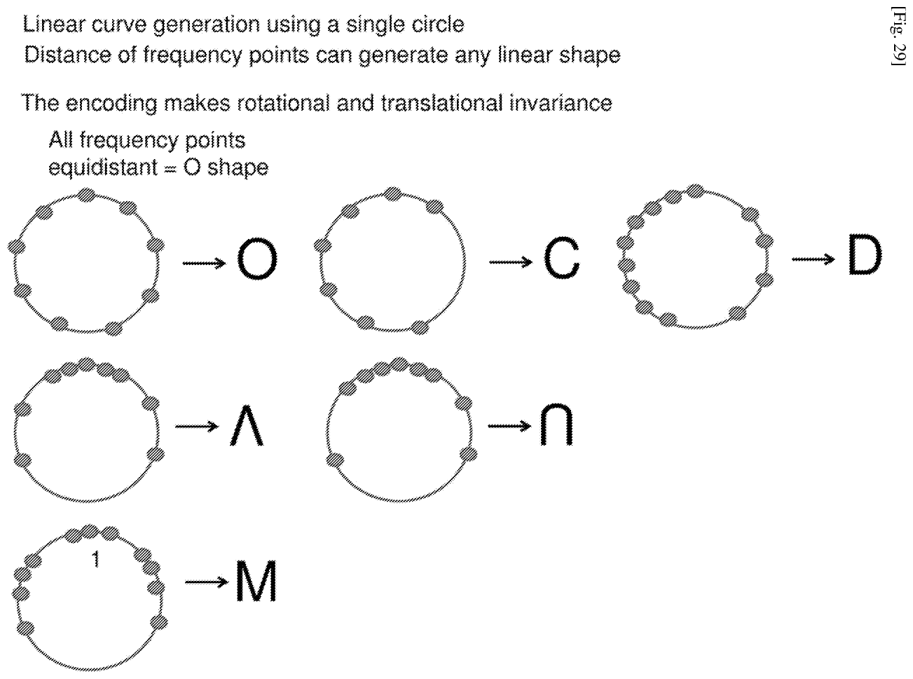

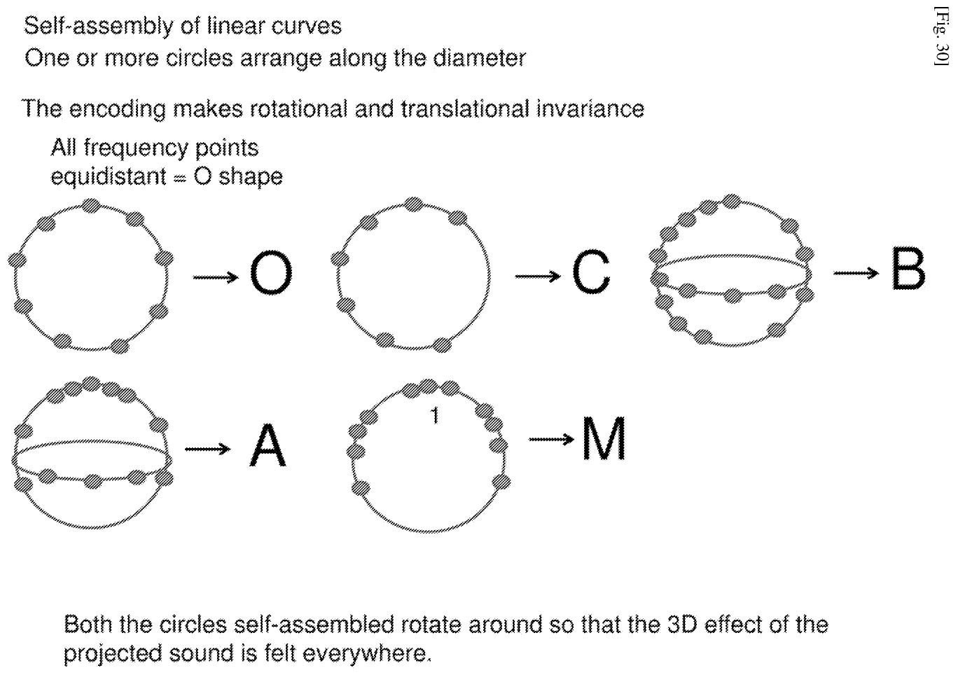

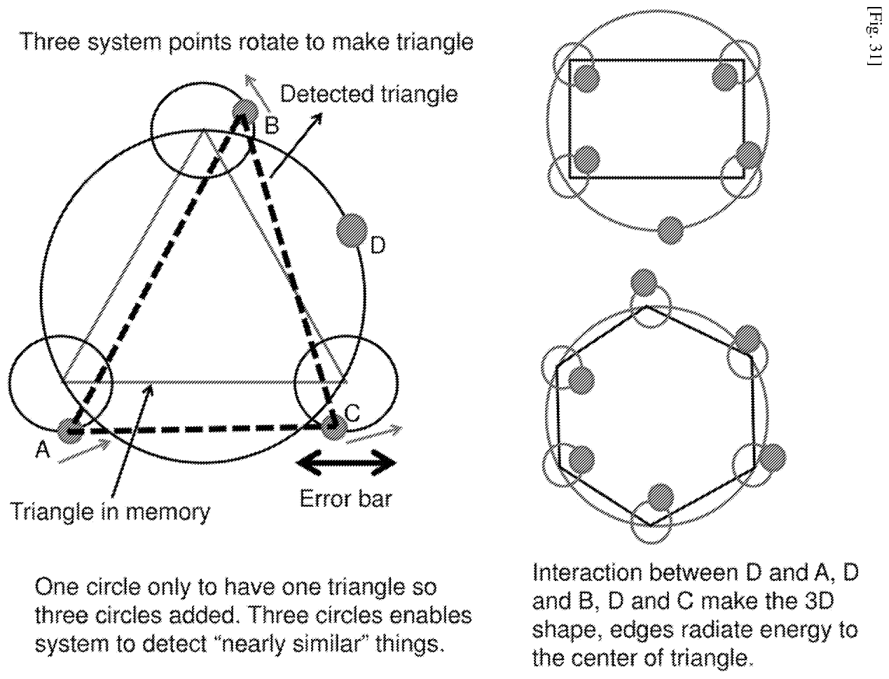

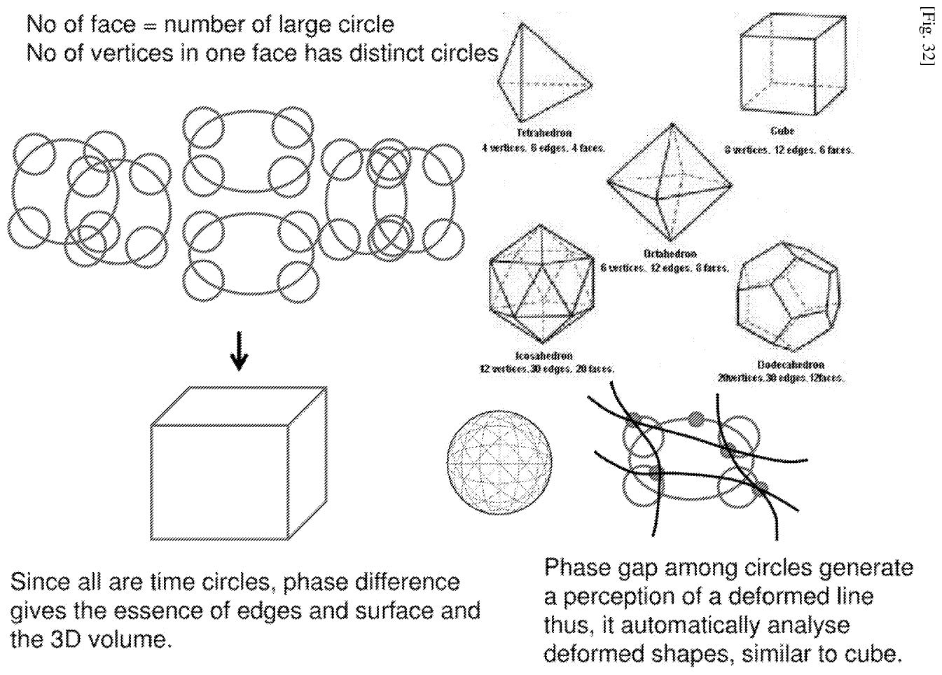

The clocking could be used to store very delicate patterns by connecting to the density of guest clocks on its surface. One such example is shown in the FIG. 29 and FIG. 30. Linear curve noted in FIG. 29 means there is no junction but corners are there. Like letter “V”, it is not linear but curved, junction means like letter “X” Apart from density of clocks as described in the FIG. 29, one could find nesting of clocks at different phase gaps to hold additional complex patterning of signals or topological features (FIG. 30). If there is any deformation in the image, the singularity area of lower clocks acts as an error bar and helps in detecting the true topology. A simple example is shown in FIG. 31. Here, a triangle could deform as much as the lower level singularity domain area permits. Within that limit, even if the input image is deformed, the time crystal could resonate to detect it. The integration of clocks via phase relationship is the key to morph any 3D feature given to the time crystal. This is explained in FIG. 32.

One experimental data is shown in FIG. 33 where microtubules resonance frequency is measured along with the change in phase as a function of time. A large number of switching of phase was tracked and then, the 3D architecture was plotted. In FIG. 33 there are three panels. Top, the resonance frequencies of a microtubule are plotted in the Log scale. The frequency values were continuously recorded for 2 minutes. During the experiment, the neighboring microtubules are continuously pumped with a white noise. No change in the resonance frequency is observed in the plot. During the same time, the phase differences between 8 peaks in the MHz domain show significant shifts with the wireless energy transfer. This happens spontaneously. After switching, the system gets back to the phase quantized state. This is the evidence that there exists a time crystal. A time crystal should be the one that operates with time even when no external perturbation is made intentionally. Using this data its equivalent time crystal made of 72 clocks is created in the bottom layer. The 3D architecture of clocking sphere was the first observed data that has led to this invention. Once observed, then the inventors synthesised organic supramolecular architectures to confirm that in an artificial molecular system also, geometric musical language (GML) could be processed.

### REFERENCE SIGNS LIST

101: unit capacitor
102: assembly of unit capacitor
305: integrated chip version of current invention in the shape of a disk
308: conical 3D version of current invention in the shape of a disk

1. A method of preparing a clock that processes geometric information:
wherein a time cycle, or clock is a pixel in the perimeter of its host time cycle, each pixel on its parameter holding a time cycle inside, and a pixel representing a phase point, and in a short-term memory, a phase cycle perpetually oscillates between its two limits, equaling as large as its host, and in a long-term memory, the diameter of time cycle decreases to become one of its pixel.
wherein a clock memorizes a geometric shape as a phase, the clock remains silent when a system point runs along the perimeter, whose phase change measures rotation, and at the corners of the geometric shape, when the clock ticks, a period of oscillation completes as a cycle, whose length of perimeter is time
wherein the ratio of arc lengths of the circle holds the distance parameters of a geometric shape and the corner is a singularity point which holds a clock inside that generates the frequency;
wherein sets of 1D, 2D and 3D basic geometric shapes change as morphing structures are used as a letter to construct geometric shape assemblies in which triangle, square, pentagon, hexagon morphs into a straight line as 2D to 1D transformation and vice versa, and those 2D shapes further transform into 3D structures by morphing.

2. The method of preparing a clock according to claim 1:
wherein a system point is defined as a controller of dynamics of entire system but it is represented as a single point on the perimeter of a circle whose motion depicts the dynamics;
wherein a guest time cycle is a circle with smaller diameter drawn on a time cycle with a larger diameter referred to as the host time cycle, both the time cycles represent a wave, so they represent guest wave or host wave, both the circles or time cycles make at least one point of contact;
wherein the creation or abolition of a system point on a circle or clock is decided spontaneously by nesting of waveforms which follows the principle that sum of the wavelengths of all the guest waves is the wavelength of the host wave, then the system point on the cycle moves automatically, wherein a perfect nesting creates a system point, if there is a mismatch, system point disappears and a clock without a system point becomes inactive;
wherein the clocks represented as circles self-assemble in three ways: (i) several circles of equal radius form a sphere; (ii) a circle is a single pixel of a circle with a larger diameter and each of its pixel has a circle inside, this structure is maintained when equal to or more than two circles combine; (iii) circles in the visible domain of an observer self-assemble in three ways in which firstly, one circle make a contact with the inner boundary of another circle secondly, both the participating circles are connected by making an external contact thirdly, one circle is overlaid on another by crossing each other's perimeter and making contact at two cross points;
wherein one circle with one system point and two circles with two system points are connected to convert a sinusoidal wave into a rhythm called nesting, and if they have just one system point on the guest, but a host has no system point then a binary pulse stream is obtained in the output, but, if all have different system points, output is a superposition of various clocks with a fixed phase relationship with each other.

3. A method of inserting clocking geometries in a Bloch sphere:
wherein a clocking circle resides in an imaginary Bloch sphere used in Quantum mechanics but instead of two classical poles of a standard Bloch sphere, they are replaced by a pair of virtual centers, and the connecting line of the virtual centers is the rotational axis of the clocking circle holding a geometric shape;
wherein the corners of a polygon or any other geometric shape residing on a clocking circle by making a contact with its perimeters are made undefined by inserting other geometric shapes inside so that those points become a singularity, and then the corner points have clocking Bloch sphere inside or a part of the host Bloch sphere is cut off to place additional Bloch spheres with similar or dissimilar geometries;
wherein a host Bloch sphere expands as new guest Bloch spheres are formed at the corner points, or side by side in a single clock with this expansion maintaining the ratio of geometric shapes, such an integrated Bloch sphere architecture is called integrated information architecture, in short to be said IIA.

4. The method of inserting clocking geometries in a Bloch sphere according to claim 3:
wherein by comparing the density of clocks in the IIA of an observer with the density of IIA of an observed object or event, it is found that the density of IIA of an observed object or event is found to be so large that its projection all around the IIA is similar and does not reflect a composition of geometries encoded within, in that case the ratio of density of IIA clocks of an observed event or object represents a mass;
wherein the assembly of clocks in IIA is such that the longest time clock or the largest time cycle of the observer's IIA's 3D projection making a solid angle with the end points of the observed objects or events IIA finds it larger than a single pixel, which connects the observer and the observed, in that case the minimum phase path between two clocking system points along the clock network is measured as space;
wherein the observer's IIA's longest clock is not a pixel to that of IIA of the observed object or event, and vice versa, in that case, the ratio of the diameters of the clocks is time; and
wherein all physical phenomena in nature is converted in only one kind of information, that is phase as part of IIA so that the dimensions of all variables like mass, space and time in the universe becomes . . . T\hat{ }−3, T\hat{ }−2, T\hat{ }−1, T, 0, T\hat{ }1, T\hat{ }2, T\hat{ }3 . . . , in which the arc gap between two “ticks” of a clocks or frequency points or coordinates of geometric shapes is represented as T, that is termed as phase, the only variable.

5. A method of shrinking big data in the integrated information architecture, IIA by using the method of claim 2:
wherein all sensory information in IIA are converted into a simple set of geometric shapes, namely a fractal seed, which is repeated following a set of rules and the entire complex architecture of information is regenerated;
wherein complex geometric patterns in the information architecture are replaced by simpler patterns, yet the projection of architecture is the same in all;
wherein IIA made of Bloch spheres changes such that its projection remains constant in all directions except one direction;
wherein the phase relationships in the information architecture change to create or delete a virtual clock without changing anything in the hardware, in which phase does not require a space to store;
wherein the relative orientations of the planes of geometric shapes in the information architecture change to add, to delete clocks, or keeping projections constant in all directions;
wherein a single Bloch sphere in the information architecture gets various planes holding distinct geometric shapes;
wherein fewer system points in the information architecture generate similar projection in all directions, thus, reducing the number of clocks required; and
wherein multiple Bloch spheres merge in the information architecture keeping the projection of the architecture unchanged in all directions.

6. The method of shrinking big data according to claim 5:
wherein the big data is sensory information;
wherein visual information is split as multilayered resolution images and each of layered images is morphed with a separate time domain clock, and finally, combined clock architecture is built;
wherein auditory information is split as groups of different time length and each set of groups is morphed with a separate time domain clock, and finally, combined clock architecture is built;
wherein taste information is split as groups of different area affected and intensity of signals, then each set of groups is morphed with a separate time domain clock, and finally, a combined clock architecture is built;
wherein touch information is split as groups of different area and intensity and each set of groups is morphed with a separate time domain clock, and finally, combined clock architecture is built;
wherein smell information is split as groups of different time length and area affected, then each set of groups is morphed with a separate time domain clock, and finally, combined clock architecture is built; and
wherein clocks belonging to different sensory signals and/or different information or arguments couple, in which couple is overlap of clocks where not more than two resonance frequencies are common to form only one integrated sensory architecture, and then if one nested rhythm is activated the other one is also activated in which to activate means for clocks to start running and for binary pulse streams to start flowing.

7. A method of building IIA using clocking materials or devices:
wherein the clock is made of a singular or plural assembly of classical or quantum oscillators, the resonance frequencies of which make the corner points of a geometric shape where a clock “ticks” or emits energy, and the phase relations between the resonance frequencies make the arc region of a circle represent a clock;
wherein the faster clocks are classical or quantum oscillators that make the membrane surface of a cavity, making the cavity vibrate as a slower clock and guest clocks occupy the neutral field region of the host clock wherein all cavities at every time and spatial scale of the self-assembled layers one above another change their shapes to edit the geometric information of clocks;
wherein clocking cavities are filled with more than one kinds of cavities in which two kinds of self-assembly processes run in parallel, first, several cavities being arranged side by side and second within and above, in order to couple clocks or geometries side by side, within and above, whereby geometries encoded in the elementary clocks morph the hardware or cavity architecture, making hardware and geometric shapes equivalent;
wherein multiple geometric perceptions of an image or pattern or complex geometric shape are written at various layers, and the simplest singular geometry that is the most prominent in the image is stored in the largest cavities where longest clocks run, and in the cavities inside, not more than two basic geometries of the complex geometric input are stored as clocks, which process goes on and on until writing of all patterns reach to the smallest pixels or the fastest clocks; and
wherein geometric shapes written in the cavities of any layer spontaneously activate in all the layers above and below, creating simpler geometric shapes, or fractal seed, and the layered clock architecture resonantly vibrates to project the complete pattern, whereby entire interconnected clocking geometries represent interconnected clocking cavities completely.
